(19) United States
(12) Patent Application Publication
(10) Pub. No.: US 2002/0154233 A1
(43) Pub. Date: Oct. 24, 2002

(54) Imaging device ,and its drive control method

(76) Inventors: Shinichi Yoshimura, Tokyo (JP); Kazuhiko Ueda, Kanagawa (JP)

Correspondence Address: BELL, BOYD & LLOYD, LLC, PO BOX 1135, CHICAGO, IL, 60690-1135, US

(21) Appl. No.: 10/030,543

(22) PCT Filed: May 8, 2001
(86) PCT No.: PCT/JP01/03835

(30) Foreign Application Priority Data
May 8, 2000 (JP) 2000-134686
Jan. 31, 2001 (JP) 2001-24493

(51) Int. Cl. H04N 3/14

(52) U.S. Cl. 348/308; 348/301

(57) ABSTRACT

An imaging system includes a photoreceptor section for generating an electric signal responsive to luminosity of an object, an amplifier section for amplifying a received optical signal, a plurality of memory sections for storing amplified electric signals as current signals, a load section for converting current outputs of said memory sections to voltages, an arithmetic section for operating an output signal from said load section, an output section for externally outputting a result of the operation, and a drive control section for controlling driving of the respective sections. A reference signal level stored in one of the memory section is compared with luminosity of an object that is stored in the other memory section while progressing integration thereof with time, and the luminosity of the object is AD-converted based on the period of time required for the luminosity signal to exceed the reference signal.

### TECHNICAL FIELD

This invention relates to an imaging system having a compact and lightweight structure, and its drive control method, which are realized by using a technique for manufacturing a semiconductor such as CMOS (Complementary Metal-Oxide Semiconductor).

Particularly, the invention relates to an imaging system made by integrating on a chip various circuit modules for processing detected signal in respective pixels, and a drive control method of the imaging system. Especially, the invention relates to an imaging system realizing AD (Analog-to-Digital) conversion and at least one additional operation by using circuit modules on a common chip, and a drive control method of the imaging system.

### BACKGROUND ART

Along with the recent rapid development of semiconductor manufacturing techniques, relatively inexpensive imaging elemental devices have been made available. As a result, portable terminals such as portable telephones and PDA (Personal Digital Assistant) with accessory or built-in small cameras have been developed and are beginning to be put on the market. Since these portable terminals should be compact and lightweight as one of their merits, associated cameras should be also compact and lightweight. Additionally, since most of portable devices are of a battery-driven type, not only the main bodies of the devices but also their accessories or built-in components are required to be low-power-consumptive.

In general, one will imagine those using CCD (Charge Coupled Device) sensors as cameras. CCD is an integrated circuit made by arranging MOS (Metal Oxide Semiconductor) electrodes as a chain, which is configured to output image data collected from an object by using its function of sequentially transferring electric charges on a semiconductor surface from an electrode to the next electrode. CCD, however, is not suitable for use in portable devices as mentioned above because of the need of a plurality of power source voltages and relatively high power consumption.

On the other hand, CMOS (Complementary Metal-Oxide Semiconductor) image sensors are being remarked as the next-generation image sensors.

Image sensors of this type, which are packaged by using the CMOS technique, satisfy the specification including compactness, small weight, low power consumption, and so on. They also permit various circuit elements realizable with CMOS techniques to be packaged on common chips. Especially, there are several reports on CMOS image sensors, each of a type integrating on a common chip the function of converting the photo diode output in each pixel on a sensor from an analog value to a digital value after noise reduction and gain correction thereof, and further conducting image processing thereof in form of the digital signal. A so-called “smart sensor” integrating the function of image processing on the sensor is particularly remarked as being widely usable from the use for games to the use for securities.

There is, for example, “CMOS Image Sensor Having the Function of Digital Image Processing” (Journal of The Institute of Image Information and Television Engineers, Vol. 53, No. 2, pp. 172-177, 1999) as a special-feature article about CMOS image sensors.

There are also papers, “CMOS Active Pixel Sensor with On-CHIP Successive Approximation Analog-To-Digital Converter” (Zhimin Zhou et al., IEEE Transactions On Electron Device, Vol. 44, No. 10, 1997), and others.

There are also U.S. patents including the patent specification of U.S. Pat. No. 5,801,657 published on Sep. 1, 1998 (entitled: SERIAL ANALOG-TO-DIGITAL CONVERTER USING SUCCESSIVE COMPARISONS).

However, almost all of these existing techniques are based on integrating an analog/digital converter (hereinafter called “AD converter”) exclusive to each pixel or each column of pixels on a chip common to the imaging device, thereby to realize a desired function. Therefore, in order to add a processing to the pixel other than that by the AD converter, a further circuit has to be integrated, which inevitably results in increasing the circuit scale of the entire image sensor chip.

Still with those existing techniques, since they each additionally need a circuit for suppressing fixed pattern noise caused by characteristics fluctuations of an amplifying transistor and a read-out transistor indispensable for each pixel, their circuit configurations become more complicated.

The literature concerning smart sensors includes reports on techniques ensuring an imaging result having a wide dynamic range, capable of reproducing bright scenes without being saturated and dark scenes without being submerged.

Existing techniques of this type include: a concept of executing logarithmic transformation of a photo diode output by using the current characteristics in a sub-threshold area of a MOS transistor (Hagiwara et al., “LOG Area Image Sensor Fabricated by Using a General CMOS Process”, Journal of The Institute of Image Information and Television Engineers, Vol. 54, No. 2, pp. 224-228, 2000), and a concept of counting how often the photo diode outputs have saturated and then converting the frequency into luminosity (Miyagawa et al., “Multi-integration Time Photoreceptor”, Journal of The Institute of Image Information and Television Engineers, Vol. 51, No. 2, pp. 256-262, 1997; Ino et al, “ADC on Image Sensor Using Integration Time Information”, Journal of The Institute of Image Information and Television Engineers, Vol. 54, No. 2, pp. 297-300, 2000).

However, the concept of conducting logarithmic conversion by using current characteristics in a sub-threshold area of a MOS transistor involves a problem in response upon a sudden decrease of the injected quantity of light, or involves the problem that the fixed-pattern noise increases under influences of noise upon a low illuminance or variation of characteristics of circuits in pixels.

The latter concepts counting the frequency of saturation of photo diode outputs and converting the frequency into luminosity involves the problem that, because it needs storage of a signal as a voltage and comparison thereof, high-speed processing is difficult and the number of bits after conversion from analog to digital is not sufficient.

It is therefore an object of the invention to provide an excellent image pickup system having a compact and lightweight structure, and a drive control method thereof.

A further object of the invention is to provide an excellent imaging system realized by using a manufacturing technique of a semiconductor such as CMOS (Complementary Metal-Oxide Semiconductor), and a drive control method thereof.

A still further object of the invention is to provide an excellent imaging system made by integrating on a common chip various circuit modules for processing detected signals in respective pixels, and a drive control method thereof.

A yet further object of the invention is to provide an excellent imaging system capable of realizing AD (Analog-to-Digital) conversion and at least one further operation by using circuit modules on a common chip, and a drive control method thereof.

A yet further object of the invention is to provide an excellent imaging system capable of obtaining an image reproducing all areas from dark ones to bright ones by enlarging the dynamic range simultaneously upon converting the received optical signal intensity from analog values to digital values, and a drive control method thereof.

### DISCLOSURE OF INVENTION

In consideration of the above-mentioned problems, according to the first aspect of the invention, there is provided an imaging system including a photoreceptor section for generating an electric signal responsive to luminosity of an object, an amplifier section for amplifying an output signal of the photoreceptor section, a plurality of memory sections for storing the electric signal amplified by the amplifier section in form of a current signal, a load section for converting current outputs from the memory sections into voltages, an operating section for operating an output signal from the load section, an output section for externally outputting a result of the operation by the operating section, and a drive control section for controlling driving of those sections, characterized in:

the drive control section having a drive control mode for controlling one of the memory sections to store a current signal corresponding to a reference signal level, controlling the other of the memory sections to store a current signal corresponding to luminosity of an object while progressing integration thereof with time, and controlling the operating section to compare luminosity of the object with the reference signal level on the basis of current signals read out from the memory sections; and

the operating section outputting an identifying signal at the moment when the signal indicative of luminosity of the object exceeds the reference signal level.

In the imaging device according to the first aspect of the invention, the drive control section may have a different drive control mode for controlling the memory sections to store current signals corresponding to luminosity of the object at different points of time, respectively, and controlling the operating section to compare luminosity of the object at respective points of time, based on current signals read out from the respective memory sections. In this case, the operating section may output an identifying signal at the moment when the signal indicative of luminosity of the object exceeds the reference signal level.

The amplifier section may include mirror transistors so connected that gate electrodes thereof are opposed to each other. In this case, the amplifier may amplify a current signal according to the current mirror principle.

The memory sections may store current signals according to the current copy principle.

By using a technique for manufacturing CMOS (Complementary Metal-Oxide Semiconductor), those sections may be packaged on a common circuit chip. For example, an imaging device can be made by providing those sections for each pixel, and packaging an optical area having a matrix arrangement of a number of pixels aligned in rows and columns, a drive circuit for generating signals for driving the respective pixels aligned in the optical area, and an output circuit for externally outputting output signals from the respective pixels. Image frames taken by the imaging device can be stored for a time in predetermined frame memory, or can be converted from a digital form to an analog form and then output as an image on a display device of the NTSC (National Television System Committee) type or the VGA (Video Graphic Array) type.

According to the second aspect of the invention, there is provided a drive control method of an imaging system including a photoreceptor section for generating an electric signal responsive to luminosity of an object, an amplifier section for amplifying an output signal of the photoreceptor section, a plurality of memory sections for storing the electric signal amplified by the amplifier section in form of a current signal, a load section for converting current outputs from the memory sections into voltages, an operating section for operating an output signal from the load section, and an output section for externally outputting a result of the operation by the operating section, which method realizes a drive control mode comprising:

(a) a step of storing a current signal corresponding to a reference signal level in one of the memory sections;

(b) a step of storing a current signal corresponding to luminosity of an object in the other of the memory sections while progressing integration thereof with time;

(c) a step of comparing a reference signal level and luminosity of the object in the operating section, based on the current signals read out from the memory sections; and

(d) a step of outputting an identifying signal from the operating section at the moment when the signal indicative of luminosity of the object exceeds the reference signal level. Duration of time required for the luminosity of the object measured by the identifying signal output in the step (d) to exceed the reference signal level can be measured. Based on the duration of time, luminosity of the object in an analog value can be converted to a digital value.

The drive control method of an imaging system according to the second aspect of the invention may further realize a different drive control mode comprising:

(p) a step of storing current signals corresponding to luminosity of the object at different points of time in the respective memory sections;

(q) a step of comparing luminosity of the object at different points of time in the operating section on the basis of current signals read out from the memory sections; and

(r) a step of outputting an identifying signal from the operating section at the moment when luminosity of the object changes. In this case, changes of luminosity of the object with time can be operated at a high speed.

According to the third aspect of the invention, there is provided an imaging system including a photoreceptor section for generating an electric signal responsive to luminosity of an object, an amplifier section for amplifying an output signal of the photoreceptor section, a plurality of memory sections for storing the electric signal amplified by the amplifier section in form of a current signal, a comparator section for introducing and comparing signals read out from the memory sections into voltages, and an output section for externally outputting a result of the comparison by the comparator section as a pixel signal, characterized in:

one of the memory sections storing a current signal corresponding to a reference signal level whereas the other of the memory sections stores a current signal corresponding to luminosity of an object; and

the comparator section comparing the reference signal level input from one of the memory sections with a signal input from the other memory section while gradually raising the reference signal level with time.

With the imaging system according to the third aspect of the invention, the electric signal generated by the photoreceptor section in response to luminosity of the object is amplified by the amplifier section, and then stored in one of the memory sections. A pixel output is obtained by reading out the electric signal from the memory section and comparing it with the reference signal level.

In order to detect dark light and express it as luminosity, it is necessary to raise the reference signal level. In contrast, in order to detect bright light and express it adequately, it is necessary to lower the reference signal level. Taking it into consideration, in the imaging system according to the third aspect of the invention, the comparator section compares the reference signal level input from one of the memory section and compares it with the signal input from the other memory section while gradually raising the reference signal level with time. Therefore, setting the reference level at a low value in a temporally early period of time where bright light is detected, and gradually raising the reference level with time can express luminosity over a wide dynamic range from dark light to bright light.

According to the fourth aspect of the invention, there is provided an imaging system including a photoreceptor section for generating an electric signal responsive to luminosity of an object, an amplifier section for amplifying an output signal of the photoreceptor section, a plurality of memory sections for storing the electric signal amplified by the amplifier section in form of a current signal, a comparator section for introducing and comparing signals read out from the memory sections into voltages, a bias section for adding a bias signal to respective signals input to the comparator section, and an output section for externally outputting a result of the comparison by the comparator section as a pixel signal, characterized in:

one of the memory sections storing a current signal corresponding to a reference signal level whereas the other of the memory sections stores a current signal corresponding to luminosity of an object; and

the bias section adding a bias signal to the signal input to one of the memory sections such that the reference signal level gradually rises with time.

With the imaging system according to the fourth aspect of the invention, the electric signal generated by the photoreceptor section in response to luminosity of the object is amplified by the amplifier section, and then stored in one of the memory sections. The comparator section uses a current signal read out from one of the memory sections as the reference signal level, and compares it with a current signal corresponding to luminosity of the object, which is read out from the other memory section, thereby to obtain a pixel output.

Here again, in order to detect dark light and express it as luminosity, it is necessary to raise the reference signal level. In contrast, in order to detect bright light and express it adequately, it is necessary to lower the reference signal level. Taking it into consideration, in the imaging system according to the fourth aspect of the invention, the bias section adds a bias signal to the signal input from one of the memory sections into the comparator section such that the reference signal level gradually rises with time, and thereby supplies the comparator section with a reference signal level that gradually rises with time. Therefore, setting the reference level at a low value in a temporally early period of time where bright light is detected, and gradually raising the reference level with time can express luminosity over a wide dynamic range from dark light to bright light.

According to the fifth aspect of the invention, there is provided a drive control method of an imaging system of a type including a photoreceptor section for generating an electric signal responsive to luminosity of an object, an amplifier section for amplifying an output signal of the photoreceptor section, and a plurality of memory sections for storing the electric signal amplified by the amplifier section in form of a current signal, thereby to output a result of comparison of signals read out from the memory sections as a pixel signal, comprising:

(a) a step of storing a current signal corresponding to a reference signal level in one of the memory sections;

(b) a step of storing a current signal corresponding to luminosity of an object in the other of the memory sections;

(c) a step of raising the reference signal level read out from one of the memory sections gradually with time;

(d) a step of comparing the current signal read out from the other memory section with the reference signal level gradually raised with time by the step (c); and

(e) a step of outputting a result of comparison by the step (d) as a pixel output.

With the imaging system according to the fifth aspect of the invention, the electric signal generated by the photoreceptor section in response to luminosity of the object is amplified by the amplifier section, and then stored in one of the memory sections. A current signal read out from one of the memory sections is used as the reference signal level, and it is compared with a current signal corresponding to luminosity of the object, which is read out from the other memory section. In this manner, a pixel output can be obtained.

Here again, in order to detect dark light and express it as luminosity, it is necessary to raise the reference signal level. In contrast, in order to detect bright light and express it adequately, it is necessary to lower the reference signal level. Taking it into consideration, in the drive control method of an imaging system according to the fifth aspect of the invention, the reference signal level read out from one of the memory sections is gradually raised with time, and this reference signal level is compared with the current signal corresponding to luminosity of the object, which is read out from the other memory section, thereby to obtain a pixel output. Therefore, setting the reference level at a low value in a temporally early period of time where bright light is detected, and gradually raising the reference level with time can express luminosity over a wide dynamic range from dark light to bright light.

An imaging system according to the invention comprises a photoreceptor section for generating an object luminosity electric signal, an amplifier section for amplifying a received optical signal, a plurality of memory sections for storing an amplified electric signal as a current signal, a load section for converting current outputs from the respective memory sections into voltages, an operating section for operating an output signal from the load section, an output section for externally outputting a result of operation, and a drive control section for controlling the driving of the respective sections.

Under the driving control by the drive control section, the current signal corresponding to the reference signal level is stored in one of the memory sections, and the current signal corresponding to luminosity of the object is stored in the other memory section while progressing integration thereof with time. Subsequently, based on the duration of time required for the luminosity of the object to exceed the reference signal level, the luminosity of the object in an analog value can be converted to a digital value.

The invention can convert luminosity of an object, which is an analog value, to a digital value by using imaging devices having a circuit arrangement for operating changes of luminosity of the object with time. Therefore, the imaging system need not include a circuit exclusive for analog-digital conversion, and can prevent an increase of the circuit scale as compared with other concepts having equivalent functions.

The invention can also realize imaging of a wide dynamic range by adjusting the time intervals for integration of the reference signal level and luminosity of the object upon the A/D conversion process for converting an analog value to a digital value.

The invention can also realize imaging resistant to random noise by integration of luminosity of the object with time upon conversion of detection signals of respective pixels from analog values to digital values.

In addition, according to the third to fifth aspects of the invention, the imaging system can enlarge the dynamic range and thereby reproduce much more portions of an image from dark areas to bright areas by preparing a plurality of frame memory, comparator and bias circuit for each pixel to variably bias signals upon analog-to-digital conversion using them.

Further objects of the invention and other aspects and advantages thereof will become apparent from the following detailed description of the invention in conjunction with the accompanying drawings.

### BRIEF DESCRIPTION OF DRAWINGS

FIG. 1 is a diagram that schematically shows a circuit configuration of an imaging device according to the first embodiment of the invention;

FIG. 2 is a diagram that shows an internal configuration of a pixel incorporated in the imaging device according to the first embodiment of the invention;

FIG. 3 is a diagram that shows a circuit configuration of a unit pixel realizing the invention in detail;

FIG. 4 is a diagram that shows the principle used to convert of an analog value of luminance into a digital value in the unit pixel shown in FIG. 3;

FIG. 5 is a diagram plotting the general equation (Equation 4) obtained from Equation 1 through Equation 3 on a graph;

FIG. 6 is a diagram plotting Equation 5 further modified from Equation 4 on a graph;

FIG. 7 is a diagram plotting a relational expression (Equation 6) of VD and VD* obtained by deleting the detection period of time, using Equation 4 and Equation 5;

FIG. 8 is a diagram that shows a timing chart of procedures for obtaining a signal used to convert luminance in an analog value into a digital value in the unit pixel shown in FIG. 3;

FIG. 9 is a diagram that shows a flow chart of procedures for obtaining a signal used to convert luminance in an analog value into a digital value in the unit pixel shown in FIG. 3;

FIG. 10 is a diagram that shows a timing chart of procedures for obtaining a signal used to convert luminance in an analog value into a digital value in the imaging unit device having the configuration shown in FIG. 1;

FIG. 11 is a diagram that shows a timing chart of procedures of respective clock pulses for operating changes in luminosity with time and detecting points of time with sharp changes in the unit pixel shown in FIG. 3;

FIG. 12 is a diagram that shows a flow chart of procedures in each unit pixel for operating changes in luminosity with time and detecting points of time with sharp changes;

FIG. 13 is a diagram that schematically shows entire configuration of an imaging system employing an imaging device 1001 according to the second embodiment of the invention;

FIG. 14 is a diagram that shows a circuit configuration of the imaging device 1001 according to the second embodiment of the invention;

FIG. 15 is a diagram that schematically shows a configuration of the unit pixel forming the imaging device 1001;

FIG. 16 is a diagram that explains the principle used to convert an analog signal value of the intensity of received light into a digital signal;

FIG. 17 is a diagram that shows the principle used to expand the dynamic range for conversion of luminance;

FIG. 18 is a diagram that shows an example of packaging about blocks of the unit pixel of the imaging device shown in FIG. 15;

FIG. 19 is a diagram that shows internal configuration of the photoreceptor section 1100 and the amplifier section 1101 in a unit pixel;

FIG. 20 is a diagram that shows internal configuration of the first memory section 1102 and the second memory section 1103 in the unit pixel in detail;

FIG. 21 is a diagram that shows internal configuration of a bias section 1105 in the unit pixel in detail;

FIG. 22 is a diagram that shows internal configuration of a comparator section 1104 and an output section 1106 in the unit pixel in detail;

FIG. 23 is a diagram that shows a timing chart of luminance conversion;

FIG. 24 is a diagram that shows a timing chart of bias voltage conversion; and

FIG. 25 is a diagram that shows a timing chart of expansion of the dynamic range.

### BEST MODE FOR CARRYING OUT THE INVENTION

Embodiments of the invention will be explained below in detail with reference to the drawings.

First Embodiment

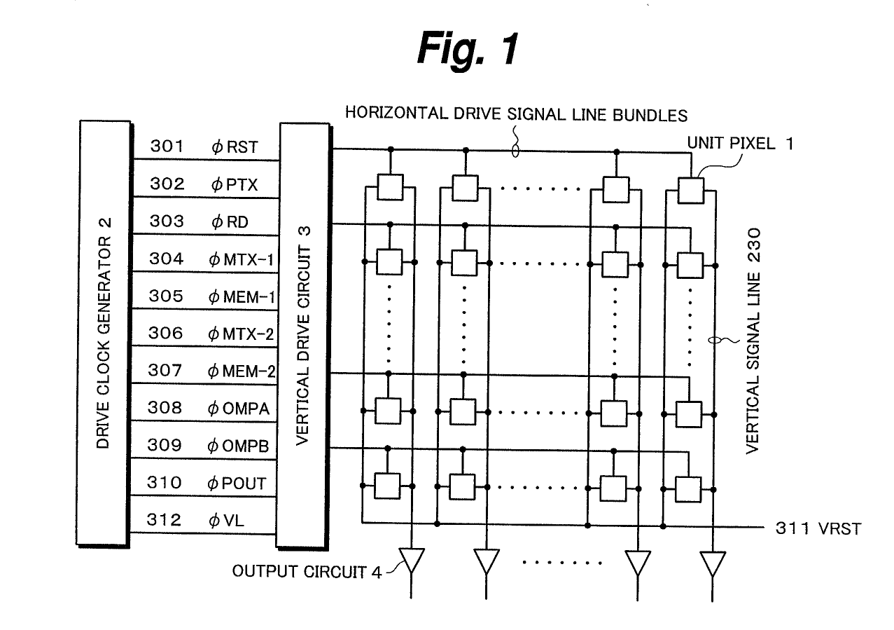

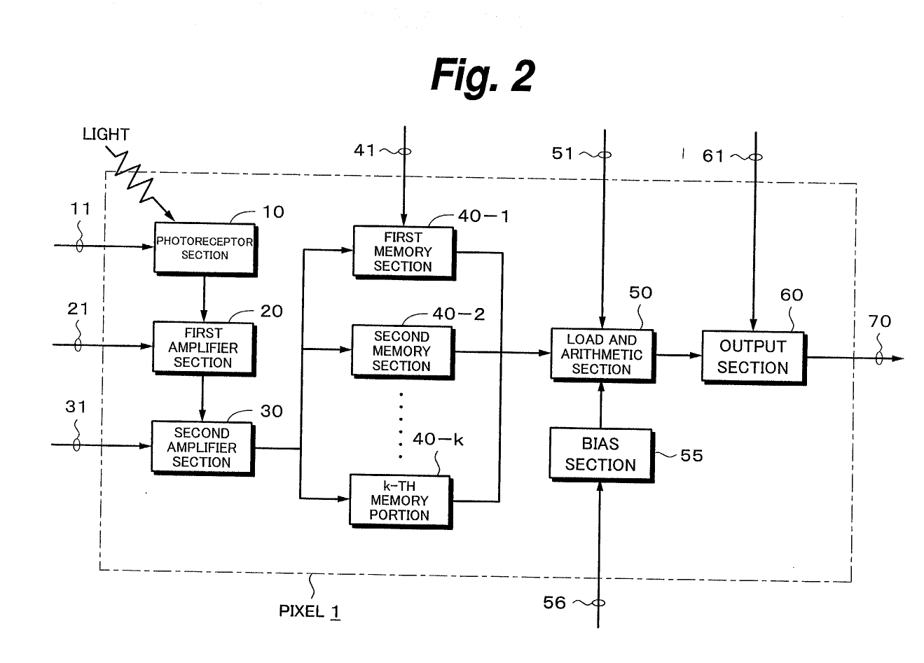

FIG. 1 schematically shows a circuit configuration of an imaging device according to the first embodiment of the invention. As illustrated here, the imaging device is made up of a two-dimensional matrix array of M×N pixels 1, including horizontal pixel drive signal line bundles each for each row of pixels and vertical signal lines each for each column of pixels.

A drive clock generator 2 is a circuit for generating clock pulses to drive unit pixels.

A vertical drive circuit 3 supplies clock pulses generated in the drive clock generator 2 to respective rows each of M unit pixels aligned in the horizontal direction via respective horizontal pixel drive signal line bundles at different working timings.

Output circuits 4 each associated with each column of pixels are configured to convert the level of each output signal from each pixel supplied through a vertical signal line 230 and to issue it outside the imaging device.

Each horizontal drive signal line bundle contains drive clock pulses supplied to each pixel, which are a reset pulse φRST (301), transfer pulse φPTX (302), received optical signal read-out pulse φRD (303), memory TR-1 transfer pulse φMTX-1 (304), memory TR-1 short-circuit pulse φMEM-1 (305), memory TR-2 transfer pulse φMTX-2 (306), memory TR-2 short-circuit pulse φMEM-2 (307), inverter A short-circuit pulse φCMPA (308), inverter B short-circuit pulse φCMPB (309), pixel read-out pulse φPOUT (310), and reset voltage VRST (311). By activating these clock pulses at predetermined timings, AD conversion and other operations can be performed to pixel output signals of the imaging device. Working timings of the drive clock pulses and procedures of operations will be explained later in greater detail.

By using, for example, a CMOS technique, all circuit modules inside the imaging device as shown in FIG. 1 can be packaged on a single chip.

FIG. 2 illustrates an internal configuration of each pixel 1 in the array inside the imaging device. As shown here, the pixel 1 includes a photoreceptor section 10, first amplifier section 20, second amplifier section 30, k memory sections from the first memory section 40-1 to the k-th memory section 40-k, load and operating section 50, bias section 55 and output section 60.

The photoreceptor section 10 is a photoelectric transducer portion for converting incident light into an electric signal, and typically a photo diode (PD). Behaviors of the photoreceptor section 10 are controlled by a photoreceptor drive signal 11.

The first amplifier section 20 amplifies a current signal transferred from the photoreceptor 10 to a level suitable for processing in the subsequent second amplifier section 30, and outputs the current signal at an appropriate timing regulated by a first amplifier drive signal 21.

The second amplifier section 30 amplifies a current signal transferred from the first amplifier 20 to a level suitable for storage in the subsequent respective subsequent memory sections 40 and also outputs the current signal at an appropriate timing regulated by a second amplifier drive signal 31.

All of k memory sections from the first memory section 40-1 to the k-th memory section 40-k are connected to the output of the second amplifier section 30, and can store currents of the amplified signals at appropriate timings regulated by a memory drive signal 41. The number k of memory sections provided in each pixel may be determined in accordance with the number required for subsequent operations.

The load and operating section 50 is connected to all outputs of the first memory section 40-1 through the k-th memory section 40-k to convert an output current from all or part of the memory sections 40 into a voltage and perform an operation at an appropriate timing regulated by an operating section drive signal 51. The content of this operation is generally an addition of signals, subtraction of signals, comparison of signals, or the like, although it depends on the function of the imaging device.

The bias section 55 generates a bias current for noise reduction necessary during the operation in the operating section 50 in response to a bias section drive signal 56.

The output section 60 converts a result of the operation by the load and operating section 50 to a level suitable for delivery to a signal line in the imaging device, and outputs it as the pixel output 70 at an appropriating timing by an output section drive signal 61.

Drive signals 11 through 61 to respective sections are provided for each pixel inside the imaging device via the horizontal pixel drive signal line bundles (mentioned above). The vertical drive circuit 3 generates these drive signals 11 through 61 and drives M pixels aligned in the horizontal direction in the unit of each row.

Pixel outputs 70 from individual pixels are connected together by each vertical signal line 230 for each pixel column. Each vertical signal line is converted to an appropriate level by the output circuit 4, and thereafter extracted as an imaging signal outside the imaging device.

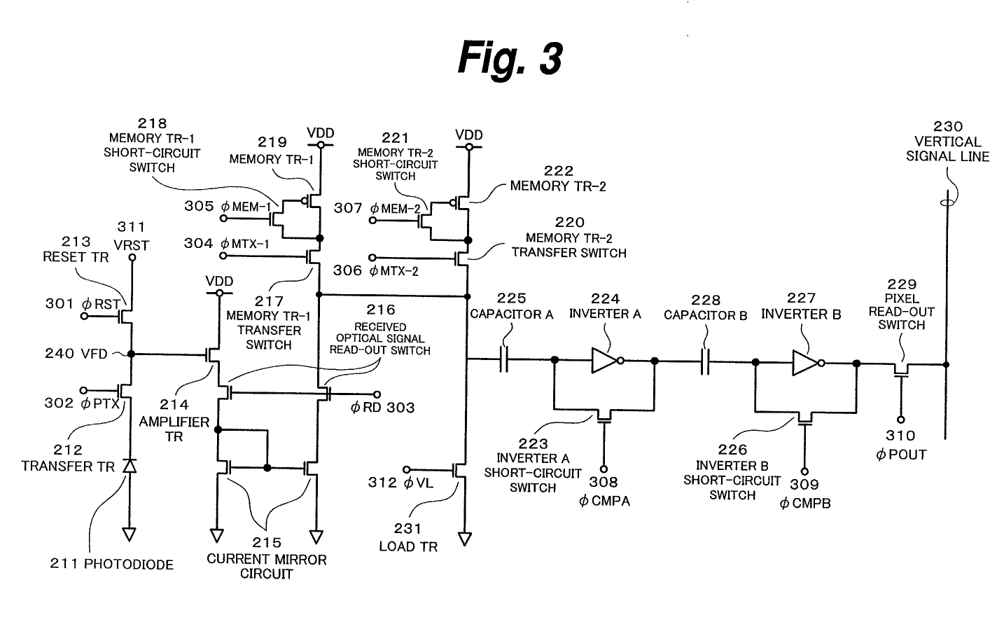

FIG. 3 shows a circuit arrangement of a unit pixel realizing the present invention in greater detail. Let the unit pixel shown here have two memory sections. Thus the configuration and working characteristics in the unit pixel shown in FIG. 3 will be explained.

A photo diode (211) performs photoelectric conversion in response to the intensity of incident light, and accumulates electrons.

Transfer TR (212) is an n-channel MOS (Metal-Oxide Semiconductor) transistor (n-MOS). Connected to its source is a photodiode (211), and connected to its drain is the gate of an amplifier TR (214). During the period where a transfer pulse φPTX (302) input to the gate of the transfer TR (212) is in the HIGH level, the transistor (212) turns ON, and electrons accumulated in the photodiode (211) are transferred and used as the gate potential of the amplifier TR (214). Let the gate voltage of the amplifier TR (214) in this status be VFD (240).

The reset TR (213) used here is an n-MOS transistor. Its source is connected to the drain of the transfer TR (212) and the gate of the amplifier TR (214), and a reset voltage VRST (311) is applied to the drain of the reset TR (213). During the period where the reset pulse φRST (301) input to the gate of the reset TR (212) is in the HIGH level, the gate potential VFD (240) of the amplifier TR (214) settles down at a value determined by the reset voltage VRST (311).

The amplifier TR (214) is an n-MOS transistor. Its gate is connected to the drain of the transfer TR (212) and the source of the reset TR 213 (213) (mentioned above), the source is connected to a received optical signal read-out switch (216), and a source voltage (VDD) is applied to the drain. In the period where the received optical signal read-out switch (216) is ON, the amplifier TR (214) can flow a current corresponding to the gate potential VFD (240) from the drain to the source.

A current mirror circuit (215) is made up of two n-MOS transistors. The source of each transistor is grounded, and the drain is connected to the received optical signal read-out switch (216). The current mirror circuit (215) has the function of amplifying the value of a current flowing from the amplifier TR (214) by the size ratio of two transistors forming the current mirror (specifically, the ratio corresponding to the ratio of gate widths if the transistors are equal in gate length) while the received optical signal read-out switch (216) is ON.

Two transistors forming the received optical signal read-out switch (216) are n-MOS transistors. The source of each of these transistors is connected to the current mirror circuit (215). The drain of one of the transistors is connected to the source of the amplifier TR (214). The drain of the other transistor is connected to sources of a memory TR-1 transfer switch (217) and the memory TR-2 transfer switch (220), load TR (231) and capacitor A (225).

During the period where the received optical signal read-out pulse φRD (303) input to the respective transistors forming the received optical signal read-out switch (216) is in the HIGH level, the current passing through the amplifier TR (214) flows into the current mirror circuit (215), and the current mirror circuit (215) amplifies the current in accordance with the size ratio of its transistors. The amplified current flows into the memory TR-1 (219) through the memory TR-1 transfer switch (217), or flows into the memory TR-2 (222) through the memory TR-2 transfer switch (220).

The memory TR-1 transfer switch (217) is an n-MOS transistor. Its source is connected to the source of the memory TR-2 transfer switch (220), load TR (231) and capacitor A (225), and also connected to the drain of the received optical signal read-out switch (216). The drain of the memory TR-1 transfer switch (217) is connected to the drain of the memory TR-1 (219) and the source of the memory TR-1 short-circuit switch (218). Thus the memory TR-1 transfer switch (217) functions to flow a current to the memory TR-1 (217) during the period where the memory TR-1 transfer pulse input to the gate, i.e. φMTX-1 (304), is in the HIGH level.

In case the period where the memory TR-1 transfer pulse φMTX-1 (304) is raised to the HIGH level coincides with the period where the received optical signal read-out pulse φRD (303) becomes HIGH level, the current flowing in the memory TR-1 (217) is the current amplified by the current mirror circuit (215), and the memory TR-1 (217) can store the current. On the other hand, in case the period where φMTX-1 (304) is raised to the HIGH level coincides with the period where the load TR pulse φVL (312) is raised to the high level, which will be explained later, the current stored in the memory TR-1 (217) flows into the load TR (231). That is, the stored content is read out.

The memory TR-1 short-circuit switch (218) is an n-MOS transistor. Its source is connected to the drain of the memory TR-1 transfer switch (217), and the drain is connected to the gate of the memory TR-1 (219). Thus the memory TR-1 short-circuit switch (218) functions to short-circuit the gate and the source of the memory TR-1 (219) during the period where the memory TR-1 short-circuit pulse φMEM-1 (305) input to the gate is in the HIGH level.

The memory TR-1 (219) is a p-channel MOS transistor (p-MOS). Its source is connected to the source voltage (VDD), and the drain is connected to the drain of the memory TR-1 transfer switch (217) and the source of the memory TR-1 short-circuit switch (218). Therefore, during the period where the memory TR-1 short-circuit pulse φMEM-1 (305) is in the HIGH level, the gate and the drain are short-circuited, and it works in the saturation region. Thus a current responsive to gate potential=drain potential flows.

Further, during the period where the memory TR-1 short-circuit pulse φMEM-1 (305) is in the LOW level, as long as the gate potential is maintained due to a relatively small gate capacity and other parasitic capacities, it is possible to store the current having flown previously and to flow the current again (current copy action) at TR-1. In this sense, the memory TR-1 (219) can work as the first memory section 40-1 shown in FIG. 2. Also because its gate capacitance is small, the memory TR-1 (219) is advantageous in executing this storage function at a high speed.

Types, connected configurations and working characteristics of the memory TR-2 transfer switch (220), memory TR-2 short-circuit switch (221) and memory TR-2 (222) as well as timings of the memory TR-2 short-circuit pulse φMTX-2 (306) and the memory TR-2 short-circuit pulse φMEM-2 (307) are the same as the types, connected configurations and working characteristics of the memory TR-1 transfer switch (217), memory TR-1 short-circuit switch (218) and memory TR-1 (219), and the timings of the memory TR-1 transfer pulse φMTX-1 (304) and the memory TR-1 short-circuit pulse φMEM-1 (305).

The load TR (231) is an n-MOS transistor. Its source is grounded, and the drain is connected to the drain of the received optical signal read-out switch (216), sources of the memory TR-1 transfer switch (217) and the memory TR-2 transfer switch (220), and capacitor A (225). Thus, during the period where the load TR pulse φVL (312) input to the gate is in the HIGH level, a voltage responsive to the flowing current is generated at the drain.

The inverter A (224) is made up of an ordinary n-MOS transistor and an ordinary p-MOS transistor (not shown), having an input connected to the capacitor A (225) and an output connected to the capacitor B (228). Further connected to the input and the output of the inverter A (224) are the source and the drain of the inverter A short-circuit switch (223).

The inverter A short-circuit switch (223) is an n-MOS transistor, and its source and drain are connected to the input and the output of the inverter A (224), respectively (pairing of the connection may be opposite). During the period where the inverter A short-circuit pulse φCMPA (308) input to the gate is in the HIGH level, the switch (223) short-circuits the input and the output of the inverter A (225).

During the period where the inverter A short-circuit switch (223) is ON, since the input and the output of the inverter A (225) are short-circuited, its output voltage settles down at a value substantially equal to one half the source voltage. Let this voltage be the working voltage V_{inv-A} of the inverter A (224).

On the other hand, during the period where the invert A short-circuit switch (223) is OFF, the potential of the output is determined depending on the potential generated in the capacitor A (225) on the input side of the inverter A (224).

The inverter B (227) is also made up of an ordinary n-MOS transistor and an ordinary p-MOS transistor having an input connected to the capacitor B (228) and an output connected to the drain of the pixel read-out switch (229). Further connected to the input and the output of the inverter B (227) are the source and the drain of the inverter B short-circuit switch (226).

The inverter B short-circuit switch (226) is an n-MOS transistor, and its source and drain are connected to the input and the output of the inverter B (227), respectively (pairing of the connection may be opposite). During the period where the inverter B short-circuit pulse φCMPB (309) input to the gate is in the HIGH level, the switch (226) short-circuits the input and the output of the inverter B (227).

During the period where the inverter B short-circuit switch (226) is ON, since the input and the output of the inverter B (227) are short-circuited, its output voltage settles down at a value substantially equal to one half the source voltage. Let this voltage be the working voltage V_{inv-B} of the inverter B (227).

On the other hand, during the period where the invert B short-circuit switch (226) is OFF, the potential of the output is determined depending on the potential generated in the capacitor B (228) on the input side of the inverter B (227).

The pixel read-out switch (229) is an n-MOS transistor. Its source is connected to the vertical signal line (230), and the drain is connected to the output of the inverter B (227) and the drain (or source) of the inverter B short-circuit switch (226). Thus, during the period where the pixel read-out pulse φPOUT (310) input to the gate is in the HIGH level, a voltage level corresponding to the output voltage is generated in the vertical signal line (230).

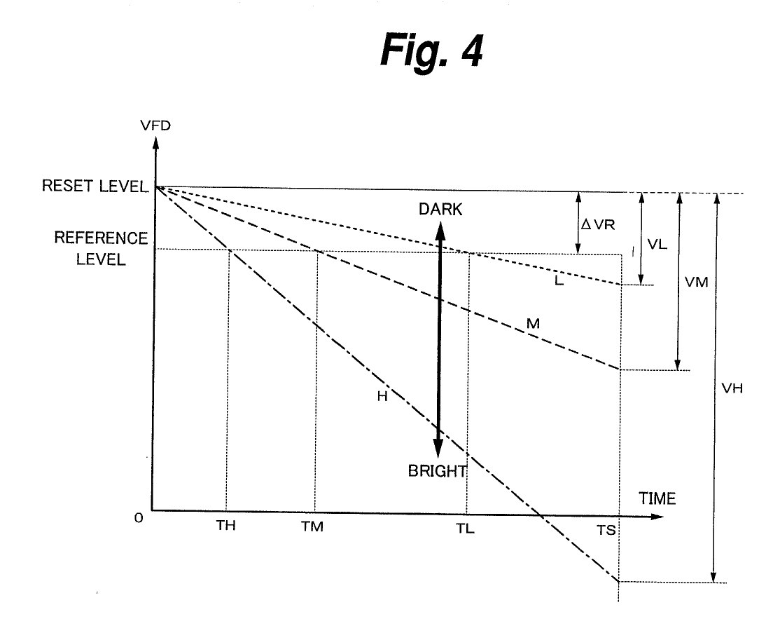

FIG. 4 shows the principle used to convert of an analog value of luminance into a digital value in the unit pixel shown in FIG. 3.

VFD is the gate potential of the amplifier TR (214) of FIG. 3 (mentioned above). Under normal behaviors, it is kept in a reset level determined by the reset voltage equal to the source voltage.

When light is illuminated to the photodiode (211), electrons by photoelectric conversion electrons are accumulated. The accumulated electrons are transferred to the gate of the amplifier TR (214) by ON-motion of the transfer TR (212). As a result, the gate potential VFD (240) drops from the reset level.

Degree of the voltage drop is proportional to the quantity of transferred electrons or the number of electrons accumulated in the photodiode (211), and this is the intensity of incident light. Therefore, as the incident light gets brighter, the drop of the gate potential VFD (240) becomes sharper. In contrast, the darker the incident light, the gentler the drop of VFD (240).

When the above-mentioned nature is utilized, brightness levels VH, VM and VL of bright light shown by the line H in FIG. 4, light of a medium brightness shown by the line M and dark light shown by the line L can be expressed by the following equations based on similar correspondence of triangles. That is,

VH=TS·ΔVR/TH (1)

VM=TS·ΔVR/TM (2)

VL=TS·ΔVR/TL (3)

where TH, TM and TL are points of time where the lines H, M and L showing brightness intersect the reference level determined when the reset voltage is the reference voltage.

As apparent from FIG. 4 and the equations, brightness of incident light can be expressed by a function of time. That is, by detecting the time from time 0 (zero) where the photodiode (211) starts accumulating light until the moment where the gate potential VFD (240), which drops every time when the transfer TR (212) turns ON, reaches the reference level, luminosity of the incident light can be obtained.

In this case, if the timing for turning ON the transfer TR (212) in a time interval of a predetermined sampling period ΔT, the point of time where VFD (240) reaches the reference level (the product of the period ΔT and the count value n) can be obtained in form of a digital value of brightness of the object (i.e. a result of AD conversion).

It will be readily understood that brightness can be also detected similarly by comparing the current upon the gate potential VFD (240) being in the reference level with a current generated by the gate potential VFD (240), which varies from time to time, every time when the transfer TR (212) turns ON while light is illuminated, instead of directly comparing the value of the gate potential VFD (240) with the reference level.

Here is made a review about the following general expression obtained from Equations 1 through 3.

VD=TS·ΔVR/TD (4)

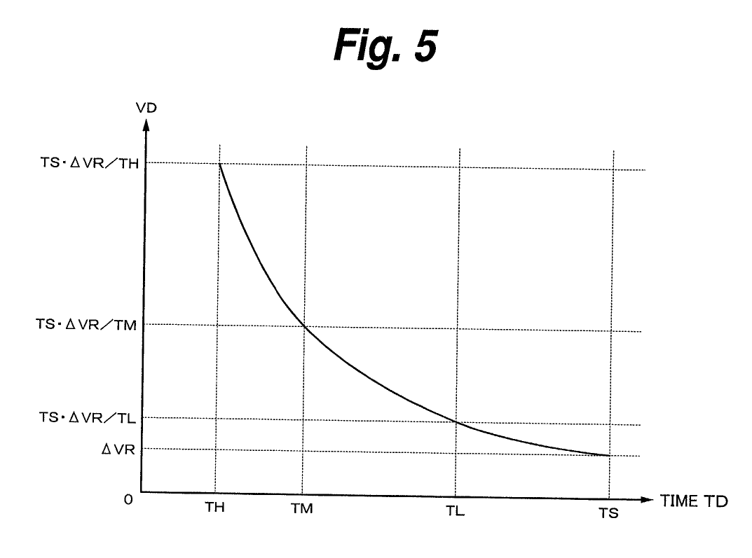

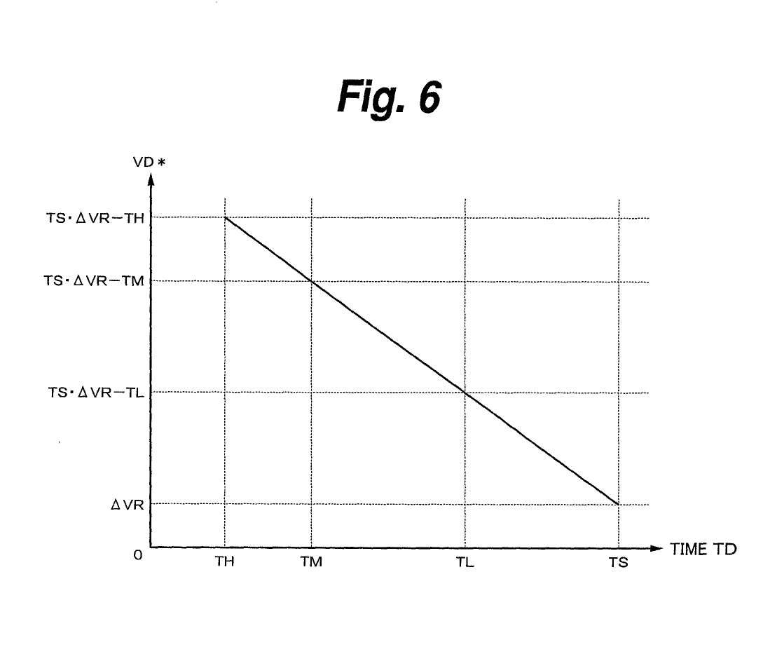

Plotting of Equation 4 on a graph results in FIG. 5, and it is understood that brightness VD obtained is in inverse proportion to the point of time of detection TD. Further, by modifying Equation 4 as follows, a linear relation is established between the brightness VD* and the point of time of detection TD. Plotting Equation 5 on a graph results in the graph shown in FIG. 6.

VD*=TS·ΔVR−TD (5)

By deleting the point of time of detection TD by using Equation 4 and Equation 5, the following relational expression established between the brightness VD and VD* is obtained.

VD*=TS·ΔVR(1−1/VD) (6)

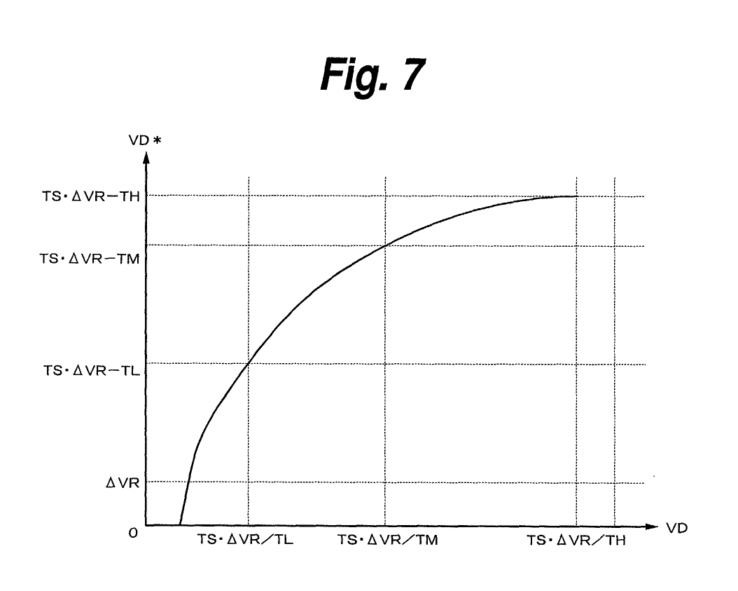

Plotting the relational expression between VD and VD* (Equation 6) results in the graph of FIG. 7. As understood from FIG. 7, since the brightness VD* stresses a dark area as compared with the brightness directly expressing the output of the photodiode PD (211), it provides a clear image with a sharp contrast.

In order to obtain such an image emphasizing a dark area (with a sharp contrast), it is general to use logarithmic conversion of the brightness VD. This, however, apparently imposes a considerable load to the processing system because it needs the logarithmic conversion, which is a nonlinear conversion, in addition to Equation 4, which is also a nonlinear conversion.

In contrast, the embodiment shown here makes it possible to readily obtain a high-contrast, clear image by expressing brightness only by linear conversion as Equation 5 from the start.

In this manner, the analog value of brightness can be converted into a digital value quantized by the time information TD sampled in time intervals. Detailed procedures of processing for AD conversion of brightness signals will be explained later.

The number of bits of the digital value depends on the sampling time interval.

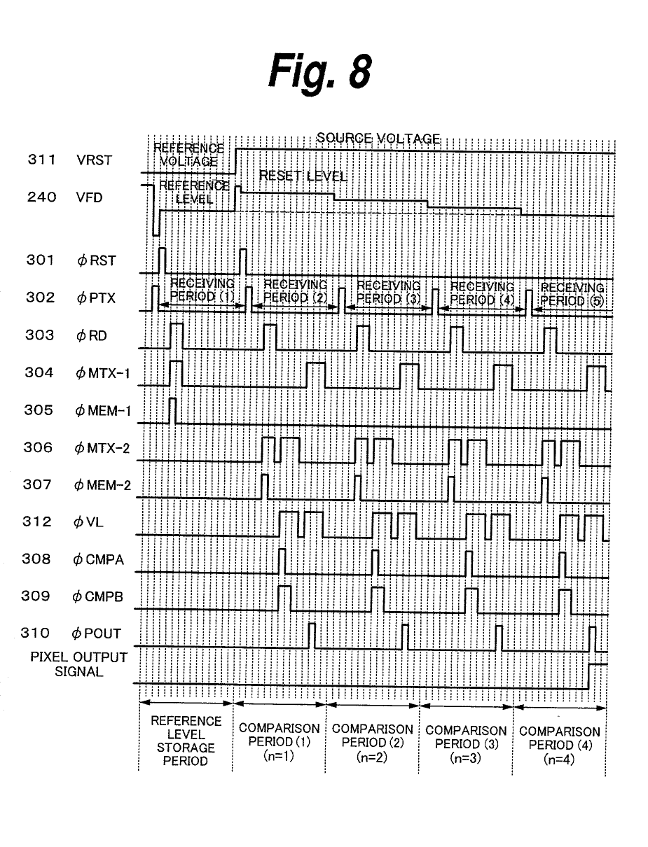

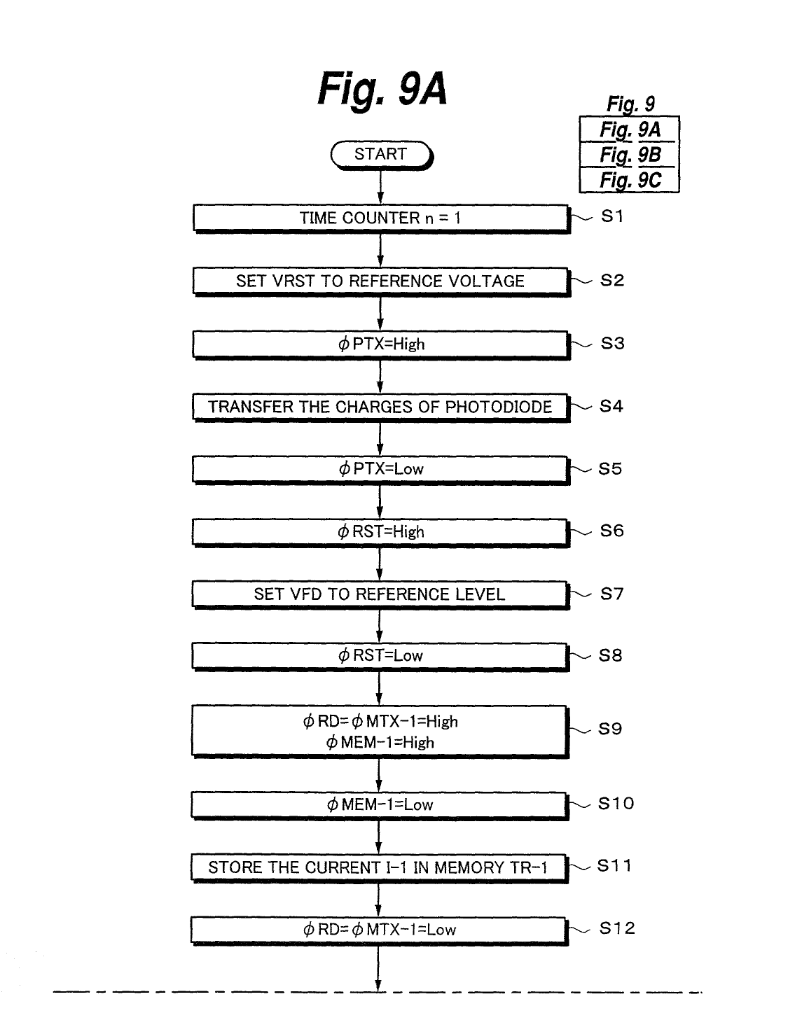

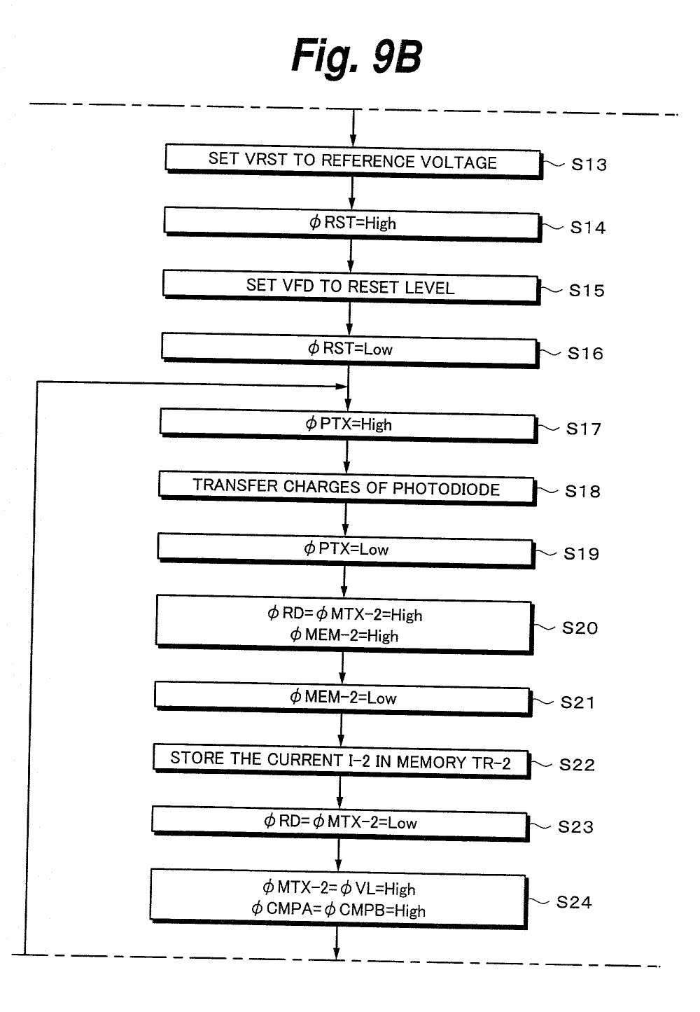

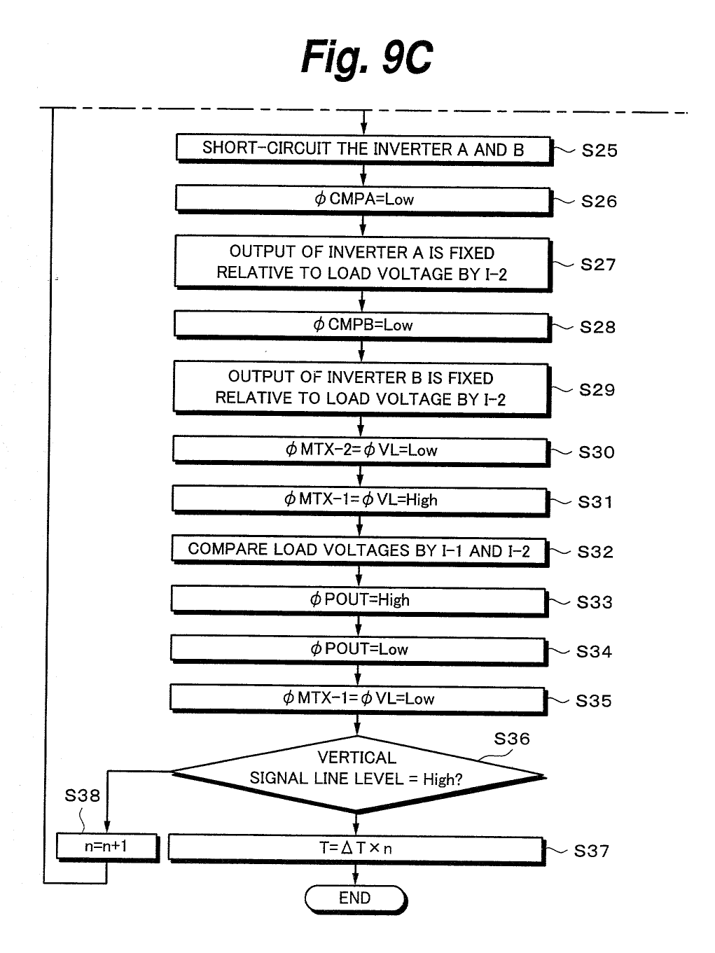

FIG. 8 shows a timing-chart of procedures for obtaining a signal used to convert luminance in an analog value into a digital value in the unit pixel shown in FIG. 3. FIG. 9 shows a flow-chart of procedures for obtaining a signal used to convert luminance in an analog value into a digital value in the unit pixel shown in FIG. 3. Referring to FIGS. 8 and 9, behaviors for AD conversion of an output of the photodiode (211) in the unit pixel of FIG. 3 are explained in detail.

First, a variable n used as the time counter is set to one (step S1). Then the reset voltage VRST (311) is set to the signal level as the reference of brightness (reference voltage) (step S2).

Subsequently, by applying a transfer pulse φPTX (302) to the gate of the transfer TR (212) (step S3), remainder electrons accumulated in the photodiode (211) in the preceding period are transferred to the gate of the amplifier TR (214) (step S4), and the transfer pulse φPTX (302) is again returned to the LOW level (step S5). At that time, however, the signal appearing at the gate of the amplifier TR (214) is not used.

After that, by applying the reset pulse φRST (301) to the gate of the reset TR (213) (step S6), the gate potential VFD (240) of the amplifier TR (214) is set to the reference level corresponding to the reference voltage (step S7), and the reset pulse φRST (301) is again returned to the LOW level (step S8).

Subsequently, for the purpose of having the memory TR-1 (219) store the current corresponding to the reference level set as explained above, the received signal read-out pulse φRD (303), memory TR-1 transfer pulse φMTX-1 (304) and memory TR-1 short-circuit pulse φMEM-2 (305) are applied simultaneously (step S9).

At that time, since the gate potential VFD (240) of the amplifier TR (214) is in the reference level as set previously, the current corresponding to that level flows into the amplifier TR (214). In addition, since the received optical signal read-out switch (216) is ON, a current amplified by the current mirror circuit (215) (hereinafter designated by “I-1”) will flow into the memory TR-1 (219). However, since the memory TR-1 short-circuit switch (218) is ON, the memory TR-1 (219) works in the saturation region.

Then, when the memory TR-1 short-circuit pulse φMEM-1 (305) is returned to the LOW level (step S10), the memory TR-1 short-circuit switch (218) turns OFF, and the memory TR-1 (219) will store the current I-1 having flown heretofore (step S11).

At that time, since the received optical signal read-out switch (216) and the memory TR-1 transfer switch (217) have to hold the ON status for a slightly longer duration than the memory TR-1 short-circuit switch (218) turns OFF, the timing for returning the received optical signal read-out pulse φRD (303) and the memory TR-1 transfer pulse φMTX-1 (304) to the LOW level is set slightly shifted (step S12).

As explained above, through steps S1 to S12, the current I-1 corresponding to the reference level of brightness can be stored in the memory TR-1 (219).

In the procedures of step S13 et seq., luminosity of the object is read out and compared with the reference level in predetermined intervals to detect the timing where the inequality between the brightness of the object and the reference level is reversed (the point where the straight line expressing the brightness intersects the reference level in FIG. 4).

First, the reset voltage VRST (311) is set at the source voltage (step S13).

Next, by applying the reset pulse φRST (301) to the gate of the reset TR (213) (step S14), the gate potential VFD (240) of the amplifier TR (214) is set to the reset level corresponding to the reset voltage VRST (step S15), and the reset pulse φRST (301) is again returned to the LOW level (step S16).

At that time, the transfer pulse φPTX (302) is applied to the gate of the transfer TR (212) (step S17). As a result, since the remainder electrons having been accumulated in the photodiode (211) have already been transferred (steps S3 through S5), electrons newly generated by photoelectric conversion (electrons generated in the light receiving period (1) of the timing chart of FIG. 8) are transferred to the gate of the amplifier TR (214) (step S18). Then the transfer pulse φPTX (302) is again returned to the LOW level (step S19).

In steps S20 through S23, a current determined by the number of electrons transferred to the gate of the amplifier TR (214) can be stored in the memory TR-2 (222).

First, by simultaneously applying the received optical signal read-out pulse φRD (303), memory TR-2 transfer pulse φMTX-2 (306) and memory TR-2 short-circuit pulse φMEM-2 (307), the current amplified by the current mirror circuit (215) is made to flow into the memory TR-2 (222). That is, a signal current (hereinafter designated by “I-2”) corresponding to the number of electrons generated in the light receiving period (1) flows into the memory TR-2 (222). However, since the memory TR-2 short-circuit switch (221) is ON, the memory TR-2 works in the saturation region.

Thus, when the memory TR-2 short-circuit pulse +MEM-2 (307) is returned to the LOW level (step S21), the memory TR-2 short-circuit switch (221) turns OFF, and the memory TR-2 (222) stores the current I-2 having flown heretofore (step S22).

At that time, since the received optical signal read-out switch (216) and the memory TR-2 transfer switch (220) here again have to hold the ON status for a slightly longer duration than the memory TR-2 short-circuit switch (221) turns OFF, the timing for returning the received optical signal read-out pulse φRD (303) and the memory TR-2 transfer pulse φMTX-2 (306) to the LOW level is set slightly shifted step S23).

In steps S20 through S23, a current corresponding to the luminosity of the object is stored in TR-2 from time to time while progressing integration thereof with time.

In the subsequent step S24 et seq., the current I-1 and the current I-2 stored in the memory TR-1 (219) and the memory TR-2 (222), respectively, are compared.

First, by applying the memory TR-2 transfer pulse φMTX-2 (306) and the load TR pulse φVL (312) to the gates of the memory TR-2 transfer switch (220) and the load TR (231), respectively, the respective transistors are turned ON. As a result, the current I-2 stored in the memory TR-2 (222) flows into the load TR (231), and a load voltage corresponding to the current value (hereinafter labeled “V2”) is generated at the drain (step S24).

Simultaneously, the inverter A short-circuit pulse φCMPA (308) and the inverter B short-circuit pulse φCMPB (309) are applied to the gates of the inverter A short-circuit switch (223) and the inverter B short-circuit switch (226), respectively. Thus, in each of the inverter A (224) and the inverter B (27), the input and the output can be short-circuited (step S25). As a result, output voltages of the inverter A (224) and the inverter B (227) become their inverter working point voltages V_{inv-A} and V_{inv-B}.

Subsequently, the inverter A short-circuit pulse φCMPA (308) is first se to the LOW level, and the inverter A short-circuit switch (223) is turned OFF (step S26). As a result, output voltage of the inverter A (224), although varying slightly from that in the short-circuited period, substantially exhibits a value near the working point voltage (hereinafter labeled “V_{inv-A2}”), and the output is fixed. The fixed output value corresponds to the value obtained when the voltage (V2) generated upon the current I-2 flowing into the load TR (231) is added to the capacitor (225) (step S27).

At that point of time, opposite ends of the capacitor A (225) are supplied with the voltage (V2) generated when the current I-2 flows into the load TR (231) and a value near the working point voltage of the inverter A (224) (hereinafter designated by “V_{inv-A1}”).

On the other hand, since the inverter B (227) is still short-circuited at that point of time, the small fluctuation in the output voltage of the inverter A (224) in the step S26 does not yet appear in the output of the inverter B (227).

After that, by setting the inverter B short-circuit pulse φCMPB (309) to the LOW level, the inverter B short-circuit switch (226) is turned OFF (step S28). As a result, output voltage of the inverter B short-circuit switch (226), although slightly varying here again, substantially holds a value near the working point voltage (hereinafter designated by “V_{inv-B2}”), and the output is fixed. The fixed output value corresponds to the output obtained when the voltage (V2) generated upon the current I-2 flowing into the load TR (231) is added to the inverter B (227) via the capacitor A (225), inverter A (224) and capacitor B (228) (step S29).

At that point of time, opposite ends of the capacitor B (228) are supplied with the output voltage V_{inv-A2} of the inverter A (224) and a value near the working point voltage of the inverter B (228) (hereinafter designated by “V_{inv-B1}”) Under the condition, by returning the memory TR-2 transfer pulse φMTX-2 (306) and the load TR pulse φVL (312) to the LOW level and turning OFF the memory TR-2 transfer switch (220) and the load TR (231), reading of the current I-2 stored in the memory TR-2 (222) is completed (step S30).

Subsequently, by again setting the load TR pulse φVL (312) to the HIGH level and simultaneously setting the memory TR-1 transfer pulse φMTX-1 (304) to the HIGH level, the load TR (231) and the memory TR-1 transfer switch (217) are turned ON (step S31). As a result, the current I-1 heretofore stored in the memory TR-1 (219) flows into the load TR (231), and a voltage (designated by “V1” below) corresponding to the current value is generated at the drain.

Thus, if the voltage V1 is lower than the voltage V2 previously generated in the load TR (231) when the current I-2 flowed, then the potential of the capacitor (225) on the side of the inverter A (224) decreases from previous V_{inv-A1} by V2−V1 (assuming that the input capacitance of the inverter A (234) is so small that it can be negligible).

Therefore, output of the inverter A (224) increases from V_{inv-A2}, and as a result, potential of the capacitor B (228) on the side of the inverter A (224) rises, and output voltage of the inverter B (227) drops.

In contrast, if the voltage V1 is higher than the voltage V2, then the potential of the capacitor A (225) nearer to the inverter A (224) rises from V_{inv-A1} by V1−V2 (assuming that the input capacitance of the inverter A (224) is so small that it can be negligible), and output of the inverter A (224) drops from V_{inv-A2}. As a result, potential of the capacitor B (228) nearer to the inverter B (227) also drops, and output voltage of the inverter B (227) rises.

That is, the current I-1 heretofore stored in the memory TR-1 (219) is larger than the current I-2 heretofore stored in the memory TR-2 (222), then V1 becomes higher than V2 between voltages generated in the load TR (231). Therefore, output of the inverter B (228) becomes high. In contrast, if the current I-1 is smaller than I-2, then the output of the inverter B (228) becomes small. In short, such working characteristics enable comparison of two stored currents in magnitude (step S32).

Under the condition, by changing the pixel read-out pulse φPOUT (310) to the HIGH level and turning the pixel read-out switch (229) ON, the output level of the inverter B (228) appears on the vertical signal line (230) depending upon the result of the comparison between the currents I-1 and I-2 (step S33). Then by returning the pixel read-out pulse φPOUT (310) to the LOW level (step S34) and subsequently returning the memory TR-1 transfer pulse φMTX-1 (304) and the load TR pulse φVL (312) to the LOW level, the flow of pixel-readout procedures is completed (step S35).

At that time, it is judged whether the level of the vertical signal line (230), i.e. the output level of the pixel then read out, is LOW or HIGH (step S36). Level judgment of the vertical signal line (230) is done by an arithmetic unit (not shown) packaged on the chip common to the imaging device or on a different chip.

If the vertical signal line (230) exhibits the HIGH level, then it is known that the current I-1 is larger than I-2, or the signal level responsive to the incident light is lower than the reference level. That is, since it can be regarded that the incident light has become bright and has crossed the reference level, the value ΔT×n obtained by multiplying the sampling period ΔT by the time counter value n is output as time information (step S37), thereby to complete the entire processing routine shown in FIG. 9.

On the other hand, if the level of the vertical signal line (230), i.e. the output level of the pixel then read out, is the LOW level, the time counter n is incremented by only one (step S38), and the flow returns to step S17 to repeat the step of transferring the charge of the photodiode (211) and subsequent steps until the vertical signal line (230) changes to the HIGH level.

The circuit module for counting the time counter n can be packaged on the chip common to the imaging device or on a different chip.

The time information ΔTxn output by the processing routine shown in FIG. 9 is the point of time at the moment where VFD (240) reaches the reference level, and it corresponds to the result of conversion of the brightness of incident light in the photodiode (211) into a digital value (already explained). In other words, the photodiode output in each pixel of the imaging device can be converted from an analog value to a digital value within the imaging device by the processing routine shown in FIG. 9.

It should be appreciated that, in order to realize AD conversion within the imaging device, it is sufficient that the drive clock generator 2 outputs respective clock pulses at the timing shown in FIG. 8.

Consequently, as shown in the timing chart of procedures of FIG. 8, by releasing the transfer pulse φPTX (302) prior to the reset pulse φRST (301) during the reference level storage period, electrons already accumulated in the photodiode (211) are discharged. As a result, the period until the transfer pulse φPTX (302) is next applied, i.e. the light receiving period (1), can be equalized to the subsequent light receiving period (2), (3) . . . such that the light receiving period for each time interval can be made constant.

According to the imagining device by the instant embodiment, imaging having a wide dynamic range can be realized by adjusting the time interval for integrating the reference signal level and the brightness of the object in A/D conversion for converting an analog value to a digital value.

Further, according to the imaging device by the instant embodiment, imaging resistive to random noise can be realized by integrating the brightness of the object from time to time upon converting the detection signal of each pixel from an analog value to a digital value.

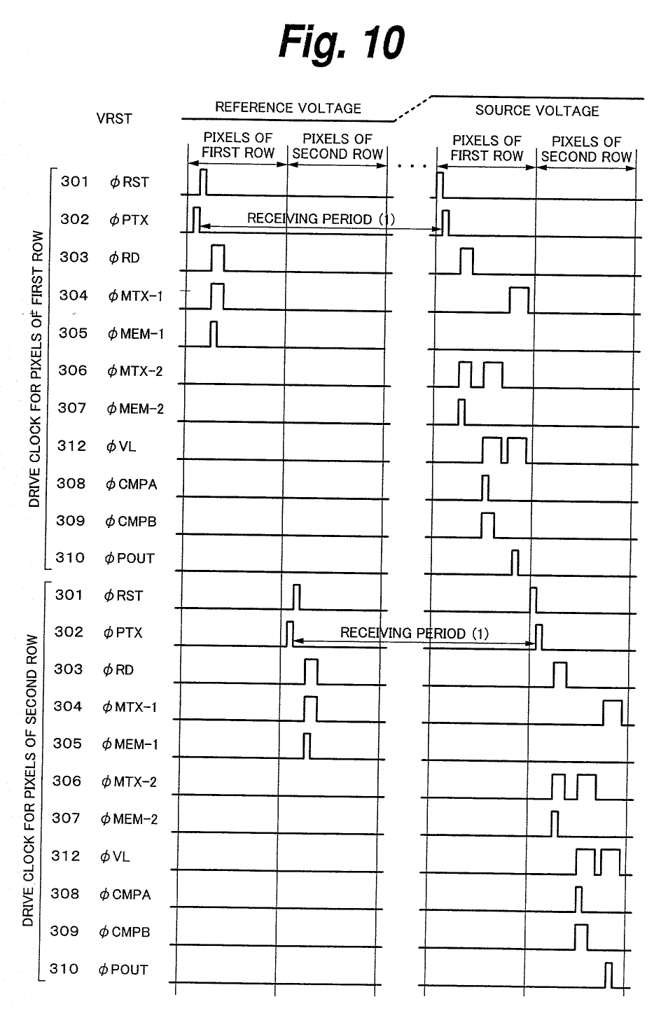

FIG. 10 shows a timing-chart of procedures for obtaining a signal used to convert luminance in an analog value into a digital value in the imaging device having the configuration shown in FIG. 1.

More specifically, FIG. 10 shows the timing of a drive clock given to pixels in the first row and pixels in the second row in two periods of time, namely, reference level storage period and comparison period (2) in the timing chart of procedures of the unit pixel of FIG. 8.

During the period where the reset voltage VRST (311) is set to the reference voltage, the reset pulse φPTX (301), transfer pulse φPTX (302), received optical signal read-out pulse φRD (303), memory TR-1 transfer pulse φMTX-1 (304) and memory TR-1 short-circuit pulse φMEM-1 (305) are simultaneously applied to all of M pixels aligned in the first row at the timing shown in the figure.

Subsequently, a predetermined period of time later, the reset pulse φPTX (301), transfer pulse φPTX (302), received optical signal read-out pulse φRD (303), memory TR-1 transfer pulse φMTX-1 (304) and memory TR-1 short-circuit pulse φMEM-1 (305) are simultaneously applied to all of M pixels aligned in the second row.

Thereafter, the same but phase-shifted drive clocks are sequentially applied (not shown) to pixels in the third to N-th rows. In this manner, in all of the unit pixels, the current corresponding to the reference level can be stored in the memory TR-1.

When the storage up to the N-th row is completed, by next setting the reset voltage VRST (311) to the source voltage and simultaneously applying the reset pulse φPTX (301), transfer pulse φPTX (302), received optical signal read-out pulse φRD (303), memory TR-2 transfer pulse φMTX-2 (306) and memory TR-2 short-circuit pulse φMEM-2 (307) to all of the pixels aligned in the first row at the timing shown in the figure, the current determined by the number of electrons by photoelectric conversion in the light receiving period (1) can be stored in the memory TR-2 (222).

Immediately thereafter, the memory TR-2 transfer pulse φMTX-2 (306), load TR pulse φVL (312), inverter A short-circuit pulse φCMPA (308) and inverter B short-circuit pulse φCMPB (309) are applied, and the current heretofore stored in the memory TR-2 (222) is read out and converted to a voltage in the load TR (231).

Subsequently, the memory TR-1 transfer pulse φMTX-1 (304) and the load TR pulse φVL (312) are applied, and the current heretofore stored in the memory TR-1 (219) is read out, converted into a voltage in the load TR (231), and compared with the voltage already read out. Then, by applying the pixel read-out pulse φPOUT (310) to the gate of the pixel read-out switch (229), the output voltage of the inverter B (227) obtained as a result of comparison is read out onto the vertical signal line (230).

Then, by simultaneously applying the reset pulse φRST (301), transfer pulse φPTX (302), received optical signal read-out pulse φRD (303), memory TR-2 transfer pulse φMTX-2 (306), and memory TR-2 short-circuit pulse φMEM-2 (307) to all of M pixels aligned in the second row similarly to the first row, the current determined by the number of electrons by photoelectric conversion in the light receiving period (1) is stored in the memory TR-2 (222).

Immediately thereafter, the memory TR-2 transfer pulse φMTX-2 (306), load TR pulse φVL (312), inverter A short-circuit pulse φCMPA (308) and inverter B short-circuit pulse φCMPB (309) are applied, and the current heretofore stored in the memory TR-2 (222) is read out and converted to a voltage in the load TR (231).

Subsequently, the memory TR-1 transfer pulse φMTX-1 (304) and the load TR pulse φVL (312) are applied, and the current heretofore stored in the memory TR-1 (219) is read out, converted into a voltage in the load TR (231), and compared with the voltage already read out. Then, by applying the pixel read-out pulse φPOUT (310) to the gate of the pixel read-out switch (229), the output voltage of the inverter B (227) obtained as a result of comparison is read out onto the vertical signal line (230).

Then by applying the same but phase-shifted drive clocks sequentially to the pixels from the third to N-th rows, it is possible to compare, in all pixels, the current corresponding to the reference level stored in the memory TR-1 (219) with the signal current proportional to the intensity of the received light stored in the memory TR-2 (222).

Each of the unit pixels in the imaging device according to the instant embodiment can apply operations other than A/D conversion to the output of the photodiode output by changing the timing between clock pulses output from the drive clock generator 2, i.e. the driving mode. For example, in each unit pixel, the point of time with a sharp change can be detected by operating changes of brightness with time.

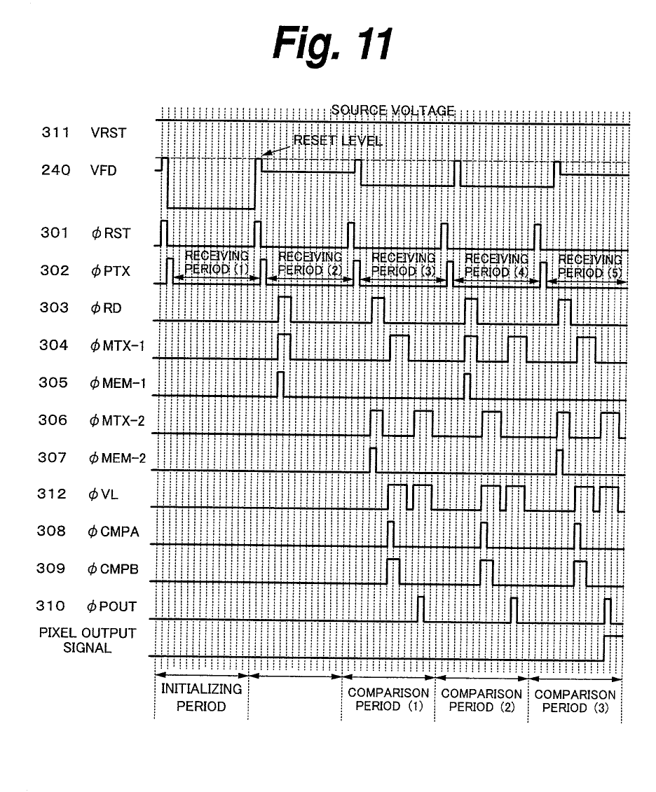

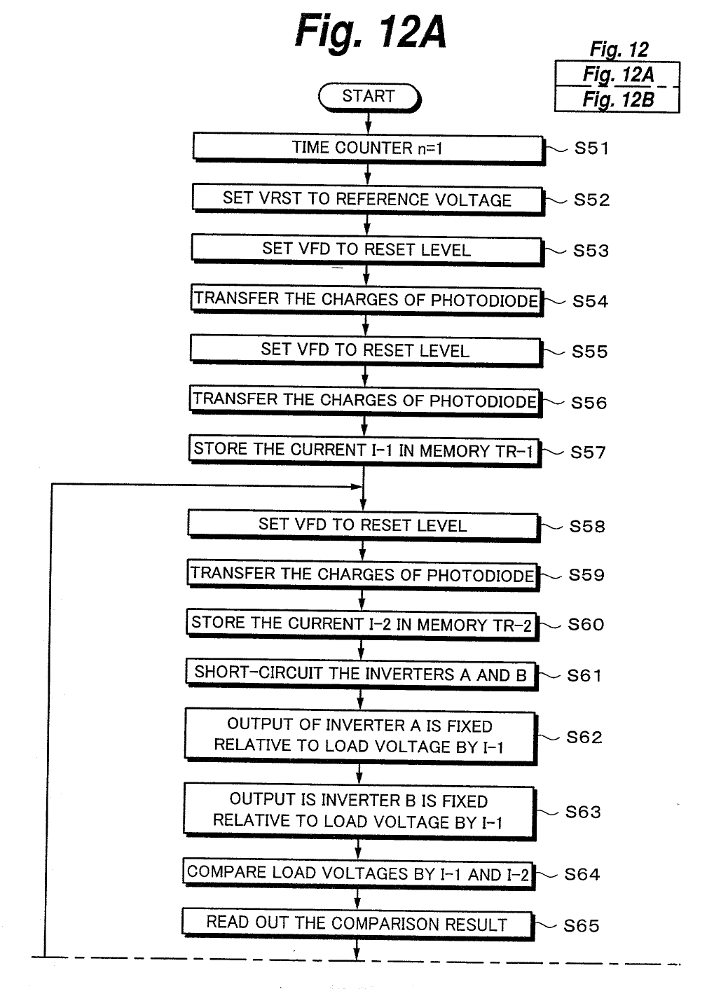

FIG. 11 shows a timing chart of respective clock pulses for operating changes in luminosity with time and detecting points of time with sharp changes in the unit pixel shown in FIG. 3. FIG. 12 shows a flow chart of procedures in each unit pixel for operating changes in luminosity with time and detecting points of time with sharp changes. Explanation is made below with reference to FIGS. 11 and 12.

First, the variable n used as the time counter is set to one (step S51). Then the reset voltage VRST (311) is set to the source voltage (step S52).

After that, by applying the reset pulse φRST (301) to the gate of the reset TR (213), the gate potential VFD (240) of the amplifier TR (214) is set to the reset level corresponding tot he source voltage (step S53), and the reset pulse φRST (301) is again returned to the LOW level.

Then, electrons accumulated in the photodiode (211) are transferred to the gate of the amplifier TR (214) (step S54). This processing corresponds to sweeping all electrons heretofore accumulated in the photodiode (211) and initializing it before starting the operation (the initializing period of FIG. 11), and it is performed by applying the transfer pulse φPTX (302) to the gate of the transfer TR (212) and thereafter returning the transfer pulse φPTX (302) to the LOW level.

Subsequently, by again applying the reset pulse φRST (301) to the gate of the reset TR (213), the gate potential VFD (240) of the amplifier TR (214) is set to the reset level corresponding to the source voltage (step S55), and the reset pulse φRST (301) is returned to the LOW level.

Then, electrons by photoelectric conversion by and accumulated in the photodiode (211) are transferred to the gate of the amplifier TR (214) in the light receiving period (1) of FIG. 11 (step S56). This processing is effected by applying the transfer pulse φPTX (302) to the gate of the transfer TR (212) and thereafter returning the transfer pulse φPTX (302) to the LOW level.

At that time, the gate potential VFD (240) of the amplifier TR (214) is determined by the number of the transferred electrons. In order to store the current generated as a result thereof in the memory TR-1 (219), each transistor may behave as explained below.

First, when the received optical signal readout pulse φRD (303), memory TR-1 transfer pulse φMTX-1 (304) and memory TR-1 short-circuit pulse φMEM-1 (305) are applied simultaneously, the above-mentioned generated current flows into the amplifier TR (214). Since the received optical signal read-out switch (216) is ON, the current amplified by the current mirror circuit (215) (hereinafter designated by “I-1”) flows into the memory TR-1 (219) via the memory TR-1 transfer switch (217). However, since the memory TR-1 short-circuit switch (218) is ON, the memory TR-1 (219) is then working in the saturation region.

When the memory TR-1 short-circuit pulse φMEM-1 (305) is returned to the LOW level, the memory TR-1 short-circuit switch (218) turns OFF, and the memory TR-1 (219) will store the current I-1 having flown heretofore (step S57).

At that time, since the received optical signal read-out switch (216) and the memory R-1 transfer switch (217) have to remain ON for a slightly longer duration than the memory TR-1 short-circuit switch (218) turns OFF, the timing where the received signal read-out pulse φRD (303) and the memory TR-1 transfer pulse φMTX-1 (304) become the LOW level is slightly offset.

As explained above, by procedures of steps S55 to S57, it is possible to store the current I-1 corresponding to the number of electrons by photoelectric conversion in the light receiving period (1) in the memory TR-1 (219).

After that, by applying the reset pulse φRST (301) to the gate of the reset TR (213), the gate potential VFD (240) of the amplifier TR (214) is set to the reset level corresponding to the source voltage (step S58), and the reset pulse φRST (301) is again returned to the LOW level.

Then, electrons generated in the light receiving period (2) in the timing chart of FIG. 11 are transferred to the gate of the amplifier TR (214) (step S59). This processing is performed by applying the transfer pulse φPTX (302) to the transfer TR (212) and thereafter returning the transfer pulse φPTX (302) to the LOW level.

At that time, the gate potential VFD (240) of the amplifier TR (214) is determined by the number of the transferred electrons. For having the resulting current stored in the memory TR-2 (222), each transistor may behave as explained below.

By simultaneously applying the received optical signal read-out pulse φRD (303), memory TR-2 transfer pulse φMTX-2 (306) and memory TR-2 short-circuit pulse φMEM-2 (307), the above explained generated current flows into the amplifier TR (214). Further, since the received optical signal read-out switch (216) is ON, the current amplified by the current mirror circuit (215) (designated by “I-2”) flows into the memory TR-2 (222) via the memory TR-2 transfer switch (220). However, since the memory TR-2 short-circuit switch (221) is ON, the memory TR-2 (222) is then working in the saturation region.

Under the condition, when the memory TR-2 short-circuit pulse φMEM-2 (307) is returned to the LOW level, the memory TR-2 short-circuit switch (222) turns OFF, and the memory TR-2 (222) will store the current I-1 having flown heretofore (step S60).

At that time, since the received optical signal read-out switch (216) and the memory TR-2 transfer switch (220) have to hold the ON status for a slightly longer duration than the memory TR-2 short-circuit switch (221) turns OFF, the timing for returning the received optical signal read-out pulse φRD (303) and the memory TR-2 transfer pulse φMTX-2 (307) to the LOW level is set slightly shifted.

As explained above, by procedures of steps S58 to S60, it is possible to store the current I-2 corresponding to the number of electrons by photoelectric conversion in the light receiving period (2) in the memory TR-2 (222).

In the subsequent steps S61 through S65, the current I-1 and the current I-2 stored in the memory TR-1 (219) and the memory TR-2 (222), respectively, are compared. This is comparison of the number of electrons generated by photoelectric conversion in the light receiving periods (1) and (2) in magnitude.

First, by applying both the memory TR-1 transfer pulse φMTX-1 (304) and the load TR pulse φVL (312), the memory TR-1 transfer switch (217) and the load TR (231) are turned on together. As a result, the current I-1 stored in the memory TR-1 (219) flows into the load TR (231), and a load voltage corresponding to the current value (hereafter designated by “V1”) is generated in the drain.

At that time, the inverter A short-circuit pulse φCMPA (308) and the inverter B short-circuit pulse φCMPB (309) are simultaneously applied to the gates of the inverter A short-circuit switch (223) and the inverter B short-circuit switch (226). As a result, both the inverter A short-circuit switch (223) and the inverter B short-circuit switch (226) turn ON, and inputs and outputs of the inverter A (224) and the inverter B (227) are short-circuited (step S61). Thus the output voltages of the invert A (224) and the inverter B (227) become the inverters' working point voltages V_{inv-A} and V_{inv-B}.

Under the condition, if the inverter A short-circuit switch (223) is turned OFF by first setting the inverter A short-circuit pulse φCMPA (308) to the LOW level, then the output voltage of the inverter A (224), although slightly fluctuating from that in the short-circuited period, substantially exhibits a value near the working point voltage (hereinafter labeled “V_{inv-A2}”), and the output of the inverter A (224) is fixed (step S62). This output value corresponds to the value obtained when the voltage V1 generated upon the current I-1 flowing into the load TR (231) is applied to the capacitor A (225).

At that point of time, opposite ends of the capacitor A (225) are supplied with the voltage (V1) generated when the current I-1 flows into the load TR (231) and a value near the working point voltage of the inverter A (224) (hereinafter designated by “V_{inv-A1}”).

On the other hand, since the inverter B (227) is still short-circuited, the small fluctuation in the output voltage of the inverter A (224) in the step S62 does not appear in the output of the inverter B (227).

Subsequently, when the inverter B short-circuit switch (226) is turned OFF by controlling the 110 inverter B short-circuit pulse φCMPB (309) to the LOW level, the output voltage of the inverter B (227), although slightly fluctuating here again, substantially maintains a value near the working point voltage ((“V_{inv-B2}” below). This value corresponds to the output obtained when the voltage V1 generated upon the current I-1 flowing into the load TR (231) is applied to the inverter B (227) via the capacitor A (225), inverter A (224) and capacitor B (228) (step S63). At this point, opposite ends of the capacitor B (228) are supplied with the output voltage V_{inv-A2} of the inverter A (224) and the voltage near the working point voltage of the inverter B (228) (“V_{inv-B1}” below), respectively.

Under the condition, by controlling the memory TR-1 transfer pulse φMTX-1 (304) and the load TR pulse φVL (312) to the LOW level and turning the memory TR-1 transfer switch (217) and the load TR (231) OFF, procedures for reading out the current I-1 stored in the memory TR-1 (219) are completed.

After that, by again changing the load TR pulse φVL (312) to the HIGH level and simultaneously changing the memory TR-2 transfer pulse φMTX-2 (306) to the HIGH level, both the load TR (231) and the memory TR-2 transfer switch (220) are turned ON. As a result, the current I-2 heretofore stored in the memory TR-2 (222) flows into the load TR (231), and a voltage corresponding to that current value is generated at the drain (“V2” hereinbelow).

If the voltage V2 previously generated in the load TR (231) when the current I-2 flows is lower than the voltage V1 generated in the load TR (231) when the current I-1 flows, then the potential of the capacitor A (225) nearer to the inverter A (224) drops from previous V_{inv-A1} by V1−V2 (assuming that the input capacitance of the inverter A (234) is so small that it can be negligible). Therefore, output of the inverter A (224) rises from V_{inv-A2}. As a result, the potential of the capacitor B (228) nearer to the inverter B (227) rises, and the output voltage of the inverter B (227) drops.

To the contrary, if the voltage V2 is higher than the voltage V1, then the potential of the capacitor A (225) nearer to the inverter A (224) rises from V_{inv-A1} by V2−V1, and output of the inverter A (224) drops from V_{inv-A2} (assuming that the input capacitance of the inverter A (224) is so small that it can be negligible). As a result, potential of the capacitor B (228) nearer to the inverter B (227) also drops, and output voltage of the inverter B (227) rises.

That is, if the current I-2 heretofore stored in the memory TR-2 (222) is larger than the current I-1 heretofore stored in the memory TR-1 (219), then V2 becomes higher than V1 between voltages generated in the load TR (231), and output of the inverter B (238) becomes higher. In contrast, if the current I-2 is smaller than I-1, then the output of the inverter B (228) becomes lower. Therefore, it is possible to compare two currents in magnitude (step S64).

Under the condition, by changing the pixel read-out pulse φPOUT (310) to the HIGH level and turning the pixel read-out switch (229) ON, the output level of the inverter B (228) appears on the vertical signal line (230) depending upon the result of the comparison between the currents I-1 and I-2 (step S65). Then by returning the pixel read-out pulse φPOUT (310) to the LOW level and subsequently returning the memory TR-1 transfer pulse φMTX-1 (304) and the load TR pulse φVL (312) to the LOW level, pixel-readout procedures are completed.

At that time, it is judged whether the level of the vertical signal line (230), i.e. the output level of the pixel then read out, is LOW or HIGH (step S66). Level judgment of the vertical signal line (230) is done by an arithmetic unit (not shown) packaged on the chip common to the imaging device or on a different chip.

If the level of the vertical signal line (230), i.e. the output of the pixel then read out, is HIGH, then it can be evaluated that the current I-2 is larger than I-1, or the electrons by photoelectric conversion in the light receiving period (2) are less than the electrons by photoelectric conversion in the light receiving period (1), that is, there was a change in luminosity due to incident light being once brighter and again becoming darker. In this case, by outputting the value ΔTxn obtained by multiplying the sampling period VT by the time counter value n (step S77), the entire processing routine shown in FIG. 12 is completed.

On the other hand, if the level of the vertical signal line (230), i.e. the output level of the pixel then read out, is LOW, then the time counter n is incremented by only one (step S67), and the flow moves to the subsequent steps.

Steps S68 through S78 correspond to the above-explained steps S58 through S67, however, replacing the roles of the memory TR-1 (219) and the memory TR-2 (222).

That is, in the steps S68 through S78, the current stored in the memory TR-2 (222) is the signal stored later than the current stored in the memory TR-1 (219). Therefore, the signal stored before has to be rewritten such that the memory TR-2 (222) stores the current corresponding to the signal newly converted photoelectrically.

For this purpose, by first applying the reset pulse φRST (301) to the gate of the reset TR (213), the gate potential VFD (240) of the amplifier TR (214) to the reset level corresponding to the source voltage (step S68), and the reset pulse φRST (301) is again returned to the LOW level.

Thereafter, electrons generated in the light receiving period (3) in the timing chart of FIG. 11 are transferred to the gate of the amplifier TR (214) (step S69). This processing is done by applying the transfer pulse φPTX (302) to the gate of the transfer TR (212) and thereafter returning the transfer pulse φPTX (302) again to the LOW level.

At that time, the gate potential VFD (240) of the amplifier TR (214) is determined by the number of the transferred electrons. To have the resulting current stored in the memory TR-1 (219), respective transistors may work as explained below.

When the received optical signal read-out pulse φRD (303), memory TR-1 transfer pulse φMTX-1 (304) and memory TR-1 short-circuit pulse φMEM-1 (305) are applied simultaneously, the above-mentioned generated current flows into the amplifier TR (214). Additionally, since the received optical signal readout switch (216) is ON, the current amplified by the current mirror circuit (216) (“I-1” below) flows into the memory TR-1 (219) via the memory TR-1 transfer switch (217). However, since the memory TR-1 short-circuit switch (218) is ON, the memory TR-1 (219) is then working in the saturation region.

Under the condition, when the memory TR-1 short-circuit pulse φMEM-1 (305) is returned to the LOW level, the memory TR-1 short-circuit switch (218) turns OFF, and the memory TR-1 (219) results in storing the current I-1 having flown heretofore (step S70).

At that time, since the received optical signal read-out switch (216) and the memory TR-1 transfer switch (217) have to maintain the ON status for a slightly longer duration than the memory TR-1 short-circuit switch (218) turns OFF, the timing where the received optical signal read-out pulse φRD (303) and the memory TR-1 transfer pulse φMTX-1 (304) change to the LOW level is offset.

In the subsequent steps S71 through S75, the currents I-1 and I-1 stored in the memory TR-2 (222) and the memory TR-1 (219), respectively, are compared. This corresponds to comparison of the numbers of electrons generated by photoelectric conversion in the light receiving periods (2) and (3).

First, by applying the memory TR-2 transfer pulse φMTX-2 (306) and the load TR pulse φVL (312) together, the memory TR-2 transfer switch (222) and the load TR (231) are turned ON. As a result, the current I-2 stored in the memory TR-2 (222) flows into the load TR (231), and the corresponding load voltage (“V2” below) is generated at the drain.

At that time, the inverter A short-circuit pulse φCMPA (308) and the inverter B short-circuit pulse φCMPB (309) are simultaneously applied to the inverter A short-circuit switch (223) and the inverter B short-circuit switch (226). As a result, the invert A short-circuit switch (223) and the inverter B short-circuit switch (226) are both turned ON, and inputs and outputs of the inverter A (224) and the inverter B (227) are short-circuited (step S71). Thus the output voltages of the inverter A (224) and the inverter B (227) become their inverter working point voltages V_{inv-A} and V_{inv-B}, respectively.

Then, when the inverter A short-circuit switch (223) is set OFF by first controlling the inverter A short-circuit pulse φCMPA (308) to the LOW level, the output voltage of the inverter A (224), although slightly fluctuating from that in the short-circuit period, substantially exhibits a value near the working point voltage (“V_{inv-A2}” below), and the output of the inverter A (224) is fixed (step S72). This voltage value corresponds to the output obtained when the voltage V2 upon the current I-2 flowing into the load TR (241) is applied to the capacitor A (225).

At the point of time, opposite ends of the capacitor A (225) are supplied with the voltage (V2) generated when the current I-2 flows into the load TR (231) and the value near the working point voltage of the inverter A (224) (“V_{inv-A1}” below).

On the other hand, since the inverter B (227) is still short-circuited, the small fluctuation of the output voltage of the inverter A (224) in the step S72 does not appear at the output of the inverter B (227).

Subsequently, when the inverter B short-circuit switch (226) is turned OFF by controlling the inverter B short-circuit pulse φCMPB (309) to the LOW level, the output voltage of the inverter B (227), although slightly fluctuating here again, substantially maintains a value near the working point voltage (“V_{inv-B2}” below). This value corresponds to the output obtained when the voltage V2 generated upon the current I-2 flowing into the load TR (231) is applied to the inverter B (227) via the capacitor A (225), inverter A (224) and capacitor B (228) (step S73). At this point, opposite ends of the capacitor B (228) are supplied with the output voltage V_{inv-A2} of the inverter A (224) and the voltage near the working point voltage of the inverter B (228) (“V_{inv-B1}” below), respectively.

Under the condition, by controlling the memory TR-2 transfer pulse φMTX-2 (306) and the load TR pulse φVL (312) to the LOW level and turning the memory TR-2 transfer switch (220) and the load TR (231) OFF, procedures for reading out the current I-2 stored in the memory TR-2 (222) are completed.

After that, by again changing the load TR pulse φVL (312) to the HIGH level and simultaneously changing the memory TR-1 transfer pulse φMTX-1 (304) to the HIGH level, both the load TR (231) and the memory TR-1 transfer switch (217) are turned ON. As a result, the current I-1 heretofore stored in the memory TR-1 (219) flows into the load TR (231), and a voltage corresponding to that current value is generated at the drain (“V1” hereinbelow).

If the voltage V1 is lower than the voltage V2 previously generated in the load TR (231) when the current I-1 flows, then the potential of the capacitor A (225) nearer to the inverter A (224) drops from previous V_{inv-A1} by V2−V1 (assuming that the input capacitance of the inverter A (234) is so small that it can be negligible). Therefore, output of the inverter A (224) rises from V_{inv-A2}. As a result, the potential of the capacitor B (228) nearer to the inverter B (227) rises, and the output voltage of the inverter B (227) drops.

To the contrary, if the voltage V1 is higher than the voltage V2, then the potential of the capacitor A (225) nearer to the inverter A (224) rises from V_{inv-A1} by V1-V2, and output of the inverter A (224) drops from V_{inv-A2} (assuming that the input capacitance of the inverter A (224) is so small that it can be negligible). As a result, potential of the capacitor B (228) nearer to the inverter B (227) also drops, and output voltage of the inverter B (227) rises.

That is, if the current I-1 heretofore stored in the memory TR-1 (219) is larger than the current I-2 heretofore stored in the memory TR-2 (222), then V1 becomes higher than V2 between voltages generated in the load TR (231), and output of the inverter B (238) becomes higher. In contrast, if the current I-1 is smaller than I-2, then the output of the inverter B (228) becomes lower. Therefore, it is possible to compare two currents in magnitude (step S74).

Under the condition, by changing the pixel read-out pulse φPOUT (310) to the HIGH level and turning the pixel read-out switch (229) ON, the output level of the inverter B (228) appears on the vertical signal line (230) depending upon the result of the comparison between the currents I-1 and I-2 (step S75). Then by returning the pixel read-out pulse φPOUT (310) to the LOW level and subsequently returning the memory TR-2 transfer pulse φMTX-2 (306) and the load TR pulse φVL (312) to the LOW level, pixel-readout procedures are completed.

At that time, it is judged whether the level of the vertical signal line (230), i.e. the output level of the pixel then read out, is LOW or HIGH (step S76). Level judgment of the vertical signal line (230) is done by an arithmetic unit (not shown) packaged on the chip common to the imaging device or on a different chip.

If the level of the vertical signal line (230), i.e. the output of the pixel then read out, is HIGH, then it can be evaluated that the current I-1 is larger than I-2, or the electrons by photoelectric conversion in the light receiving period (3) are less than the electrons by photoelectric conversion in the light receiving period (2), that is, there was a change in luminosity due to incident light being once brighter and again becoming darker. In this case, by outputting the value ΔT×n obtained by multiplying the sampling period VT by the time counter value n (step S77), the entire processing routine is completed.

On the other hand, if the level of the vertical signal line (230), i.e. the output level of the pixel then read out, is LOW, then the time counter n is incremented by only one (step S77), and the flow returns to step S58 to repeat the same procedures.

Subsequently, operations of changes of luminosity with time are sequentially executed such as comparison of the numbers of electrons generated in the light receiving periods (3) and (4), respectively, and comparison of the number of electrons generated in the light receiving periods (4) and (5), respectively.

In this manner, by replacing the memory TR for storing the current signal corresponding to the photodiode output every light receiving period and changing the read-out order upon comparison, it is always possible to judge whether the temporally later signal is larger than the preceding signal, using the same reference.

As a result of executing the procedures shown in FIGS. 11 and 12, each unit pixel of the imaging device according to the instant embodiment can catch any change of luminosity with time and can detect temporal peaks of luminosity at a high speed.

By using an imaging device made of unit pixels having the working characteristics as shown in FIGS. 11 and 12, changes of luminosity of an object with time can be obtained by, for example, obtaining an image of the object taken in the first frame and an image of the object taken in the second frame.

By using an imaging device capable of changes of luminosity of an object with time, an active type distance measurement system for measuring the distance to an object can be made according to the principle of so-called triangulation method. Active type distance measurement system of this type is disclosed in, for example, the specification of Japanese Patent Application No. 2000-107723 assigned to the present Applicant. Principles of active type distance measurement are taught by, for example, “Three-dimensional Image Measurement” (Iguchi and Sato, Shokodo Co., Ltd.).

It is of course that each unit pixel according to the embodiment can perform operations of the photodiode output other than those explained above (AD conversion, detection of the point of time with a sharp change, and so on) by changing the timing of respective clock pulses output from the drive clock generator 2.

Second Embodiment

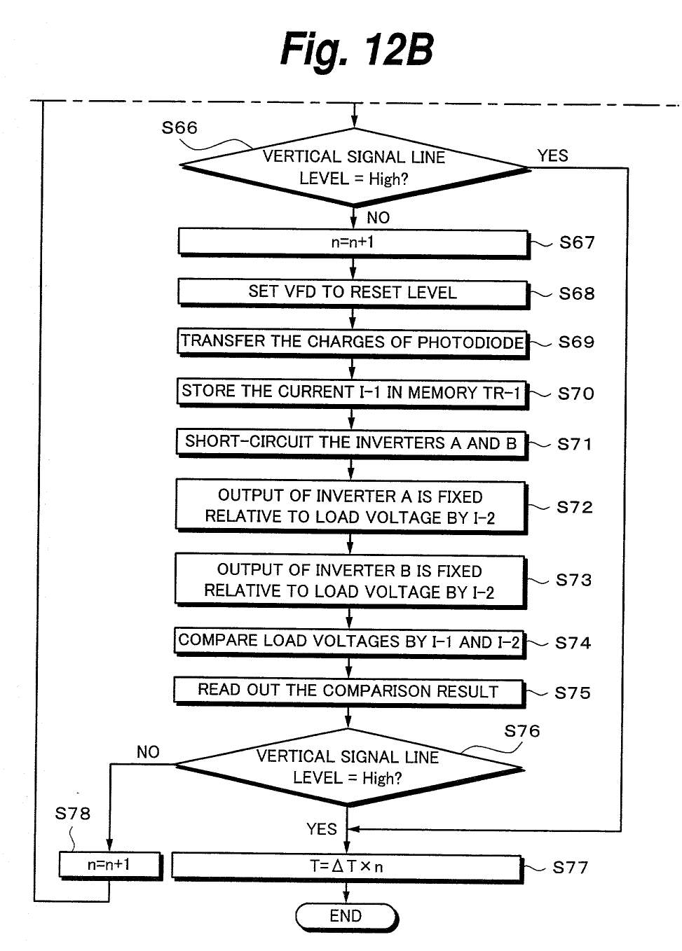

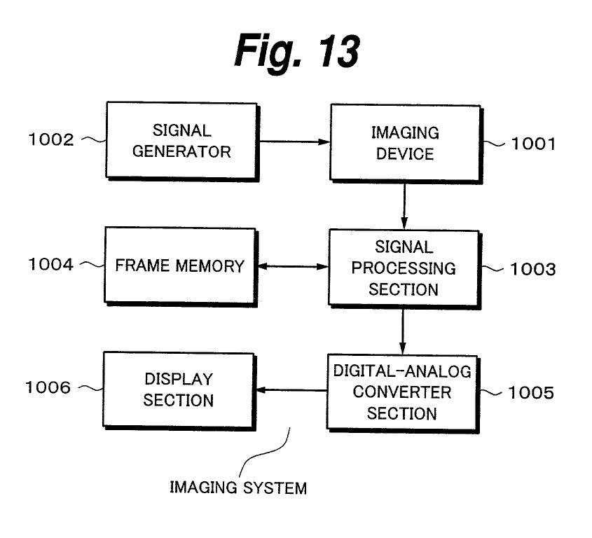

FIG. 13 shows schematically shows entire configuration of an imaging system employing an imaging device 1001 according to the second embodiment of the invention.

A signal generator 1002 generates signals necessary for driving the imaging device 1001. Respective signals, generated, are input to the imaging device 1001, and delivered by a vertical scanner 1020 inside the imaging device 1001 as pixel control signals to respective pixels 11 forming the imaging device 1001.

A frame memory 1004 has address spaces corresponding to the number of pixels forming the imaging device 1001, and its data width has a size large enough to express an imaging result of the imaging device 1001. The frame memory 1004 is connected to the signal processing section 1003 by a bi-directional bus so as to input and store processing results of each pixel generated in the signal processing section 1003 and, in contrast, deliver its storage content to the signal processing section 1003 if necessary.

The signal processing section 1003 inputs an output signal of the imaging device 1001, processes it for each pixel in the original form of digital data, and outputs its result to the frame memory 1004.

A digital-analog converter section 1005 inputs a digital signal for each pixel from the signal processing section 1003, converts it into an analog signal, and outputs it.

A display section 1006 inputs an analog signal output from the digital-analog converter section 1005, and outputs it for display on a screen (not shown).

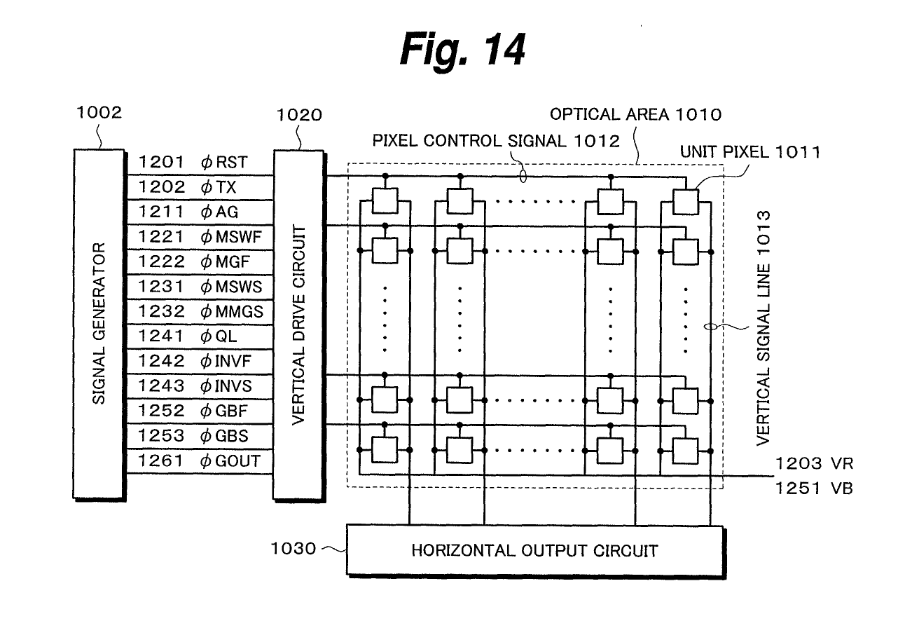

FIG. 14 schematically shows a circuit configuration of the imaging device 1001 according to the second embodiment of the invention. As illustrated here, the imaging device 1001 is made up of a two-dimensional matrix array of M×N pixels 1, including pixel control signal lines 1012 each for each row of pixels and vertical signal lines 1013 each for each column of pixels. N vertical signal lines 1013 from individual pixel columns are connected to a horizontal output circuit 1030, and its output signal is converted into serial format and output to the exterior of the imaging device 1001, or output outside the imaging device 1001 in parallel for increasing the output rate.

The signal generator 1002 is a circuit for generating clock pulse signals for driving unit pixels at predetermined timings, respectively.

A vertical drive circuit 1020 supplies clock pulse generated in the signal generator 1002 to respective rows each of M unit pixels aligned in the horizontal direction via respective pixel control signals at different working timings.

Each pixel control signal line 1012 shown in FIG. 14 collectively contains a photoreceptor control pulse 1200 for driving each pixel, amplifier control pulse 1210, first memory control pulse 1220, second memory control pulse 1230, comparator control pulse 1240, bias control pulse 1250, and output control pulse 1260 (explained later). By activating these drive clock pulses at predetermined timings, AD conversion and other operations can be performed to pixel output signals of the imaging device. Working timings of the drive clock pulses and procedures of operations will be explained later in greater detail.

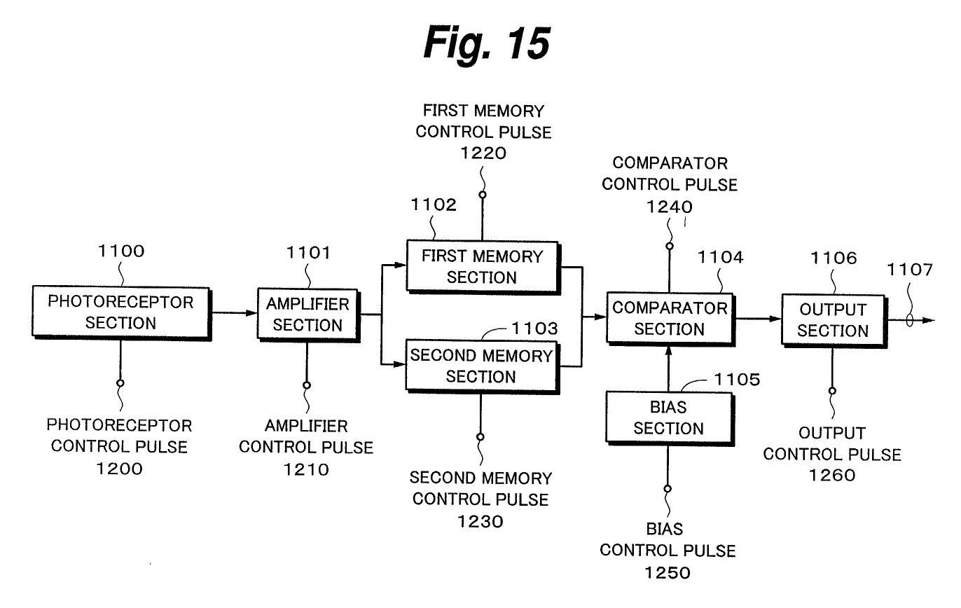

FIG. 15 schematically illustrates a configuration of the unit pixel forming the imaging device 1001. As shown here, the pixel includes a photoreceptor section 1100, amplifier section 1101, first memory section 1102, second memory section 1103, comparator section 1104, bias section 1105 and output section 1106.

The photoreceptor section 1100 outputs to the amplifier section 1101 a signal obtained by photoelectric conversion in response to its intensity of incident light.

The photoreceptor control pulse 1200 is an input pulse for controlling the resetting of the internal status of the photoreceptor section 1100 and the internal transfer of the photoelectrically converted signal, and it contains a reset pulse φRST (1201) and a transfer pulse φTX (1202).

The amplifier section 1101 outputs a signal obtained by amplifying an output signal input from the photoreceptor 1100 to the first memory section 1102 and the second memory section 1103.

The amplifier control pulse 1210 is an input pulse for controlling whether or not the signal amplified by the amplifier section 1101 is output, and it contains an amplifier read-out pulse φAG (1211).

The first memory section 1102 and the second memory section 1103 are configured to store a signal output from the amplifier section 1101 and output it to the comparator section 1104.

The first memory control pulse 1220 and the second memory control pulse 1230 control signal recording operation and signal read-out operation with the first memory section 1102 and those with the second memory section 1103, respectively. The first memory control pulse 1220 includes a first memory pulse φMSWF (1221) and a first memory gate pulse φMGF (1222). The second memory control pulse 1220 includes a second memory pulse φMSWS (1231) and a second memory gate pulse φMGS (1232).

The comparator section 1104 inputs signals read out from the first memory section 1102 and the second memory section 1103, and outputs a signal of 0 (LOW level) or 1 (HIGH level) as a result of their comparison.

The comparator control pulse 1240 is an input pulse for controlling operations of the comparator section 1104, and it includes a load pulse φQL (1241), first inverter short-circuit pulse φINVF (1242) and second inverter short-circuit pulse φINVS (1243).

The bias section 1105 adds a bias signal to two input signals by applying the bias signal to the comparator section 1104.

The bias control pulse 1250 is an input pulse for controlling the bias signal output from the bias section 1105, and it includes a first bias gate pulse φGBF (1252) and a second bias gate pulse φGBS (1253).

The output section 1106 outputs a signal indicative of the comparison result of the comparator section 1104 as a pixel signal 1107 outside the unit pixel.

The output section control pulse 1260 is an input pulse for controlling behaviors of the output section 1106, and it includes an output gate pulse φGOUT (1261).

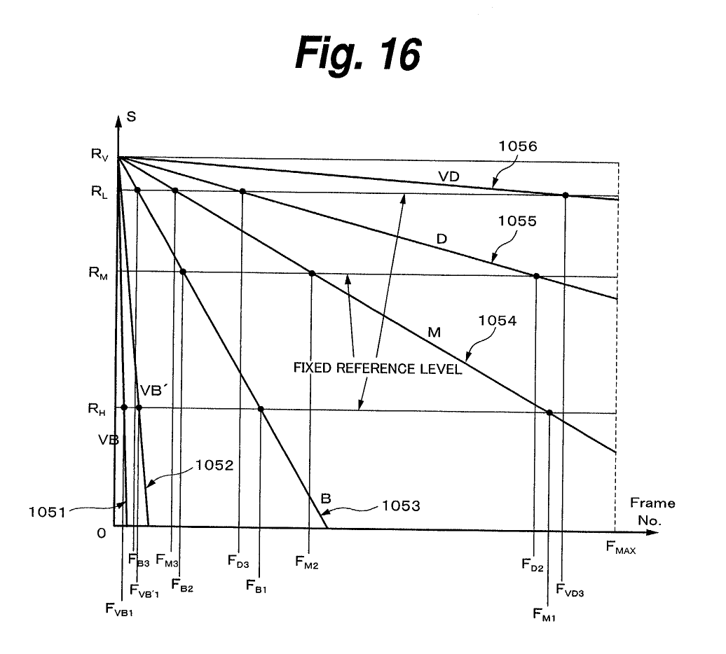

Next referring to FIG. 16, the principle used to convert the intensity of incident light, which is an analog signal value, into a digital signal in the unit pixel explained above.

The period of time, starting as from reception of light by the pixel, through storage of the signal in one of the memory sections 1102, 1103, until reading, comparing and outputting it, is defined as “one frame” in the present specification.

The abscissa of the graph shown in FIG. 16 exhibits frame numbers to indicate how many frames are repeated, which output comparison results, after receiving light at the photoreceptor sections 1100, that is, to indicate when how many times the comparison is done, the pixel output is inverted from 0 to 1. The maximum frame number is defined as F_{MAX}, and let single imaging be completed by repeating comparison F_{MAX} times.

The ordinate of the graph shown in FIG. 16 exhibits a signal quantity S of optical intensity in the photoreceptor section 1100. The change of the signal quantity with time upon receipt of very bright light is expressed by VB (1051), and the change with time upon receipt of slightly darker light is expressed by VB′ (1052). Further, the change upon receipt of bright light is expressed by B (1053), the change upon receipt of light of a medium luminosity is expressed by M (1054), the change upon receipt of dark light is expressed by D (1055), the change upon receipt of very dark light is expressed by VD (1056), and changes of the signal quantity with time upon receipt of light are expressed by straight lines, respectively. In the example shown in FIG. 16, it is assumed that a difference in luminosity is expressed by gradient of a straight line, that is, by magnitude of changes of the signal quantity with time. Therefore, as the light gets brighter, the gradient becomes sharper, and the darker the light, the gentler the gradient.

Assume here a reference signal whose signal quantity is constant value of R_{H} all time. Then, let it be tried to obtain the number of frames or time required for each straight line corresponding to a respective change of luminosity with time to intersect the reference signal level R_{H}. By making use of the nature that the fewer the frames until intersecting the reference level, the brighter the light, and the more the frames for intersecting the reference level, the darker the light, luminosity of the received light can be expressed. Since the numbers of frames are discrete, that is, since they are digital values, luminosity obtained is also expressed in a digital value.

Under that condition, the frame number corresponding to the crossing point with VB (1051) is F_{VB1} as illustrated. The crossing point with VB′ (1052) is F_{VB′}, crossing point with B (1053) is F_{B1}, and crossing point with M (1054) is F_{M1}. On the other hand, there are no crossing points with D (1055) and VD (1056).

In this case, luminosity of the received light can be expressed by the following equation using a constant K and frame numbers of crossing points with the reference signal level.

I_{VB}=K/F_{VB1} (7)

I_{VB}=K/F_{VB′1} (8)

I_{B}=K/F_{B1} (9)

I_{M}=K/F_{M1} (10)

When the reference signal level is RH, dark light D1055, and very dark light VD 1056 have no crossing points within the maximum time or the maximum frames given here, and their luminosity cannot be expressed. To cope with it, when the reference signal level is raised from R_{H} to R_{M}, then the straight line D (1055) can have a crossing point at the frame F_{D2}, as shown in FIG. 16. If the reference level is further raised to R_{L}, the straight line VD can intersect at the frame F_{VD3}. That is, it is possible to consider that raising the reference level is equivalent to increasing the gain of luminosity.

For example, when the reference level is R_{L}, luminosity of each light can be expressed by the following equations.

I_{VB}=K/F_{VB1} (11)

I_{VB′}=K/F_{VB1} (12)

I_{B}=K/F_{B3} (13)

I_{M}=K/F_{M3} (14)

I_{D}=K/F_{D3} (15)

I_{VD}=K/F_{VD3} (16)

It should be noted here that Equation 11 is identical to Equation 7, and also identical to Equation 12, which must be different in luminosity. This is the phenomenon that occurs when the frame F_{VB1} is the minimum unit of the time basis and it is the first frame. In other words, when a certain frame is the first frame and the pixel output is 1, as far as it is expressed by the above equation, it is not possible to distinguish a difference in luminosity, even though there is a difference actually. To prevent this phenomenon, it is preferable to set the reference level as low as possible for bright light.

Based on the discussion made above, in order to detect dark light and express it in luminosity, it is necessary to raise the reference level (this corresponds to raising the gain). On the other hand, for expressing bright light, it is necessary to lower the reference level (this corresponds to decreasing the gain). Thus the skilled in the art will understand that any luminosity of light from dark light to bright light can be expressed over a wide dynamic range by setting the reference level to a low value for the temporally early period where bright light is detected, i.e. in the range with small numbers of frames and gradually raising the reference level with time.

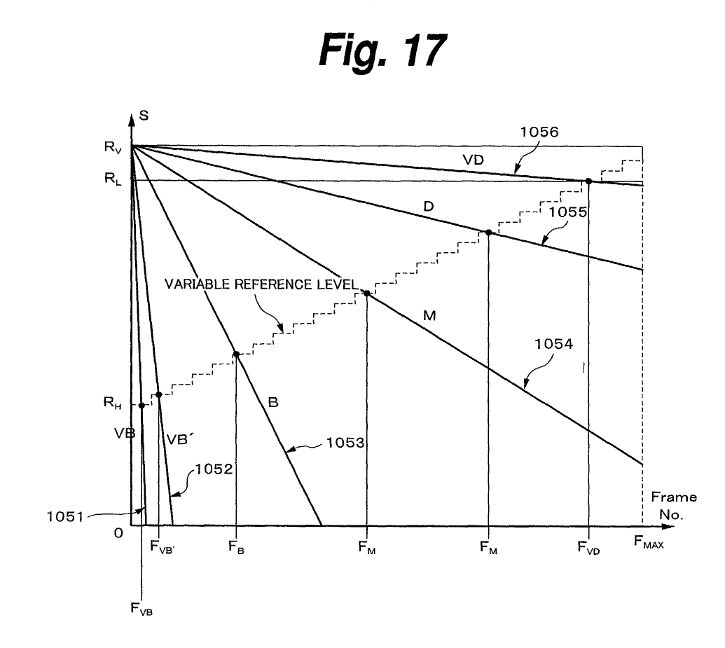

FIG. 17 shows an example of this kind of way of setting the reference level. In this example shown here, the initial reference level starts from R_{H} and gradually (step-by-step with time) increases up to the final value R_{L}. As to the mode of increasing the reference level, it may be changed bit by bit every frame, or changed every several frames.

Following the principle of expansion of the luminance conversion dynamic range shown in FIG. 17, luminance of each received light can be expressed as follows from the crossing point of each straight line indicating the luminance and the reference level.

I_{VB}=K/F_{VB} (17)

I_{VB′}=K/F_{VB′} (18)

I_{B}=K/F_{B} (19)

I_{M}=K/F_{M} (20)

I_{D}=K/F_{D} (21)

I_{VD}=K/F_{VD} (22)

Following the way of expressing luminosity according to FIG. 17, both very bright VB (1051) and very dark VD (1056) can be expressed simultaneously, i.e., in the same system.

Next explained is an example of a implemented circuit employing the system enabling realization of imaging of a wide dynamic range as explained above.

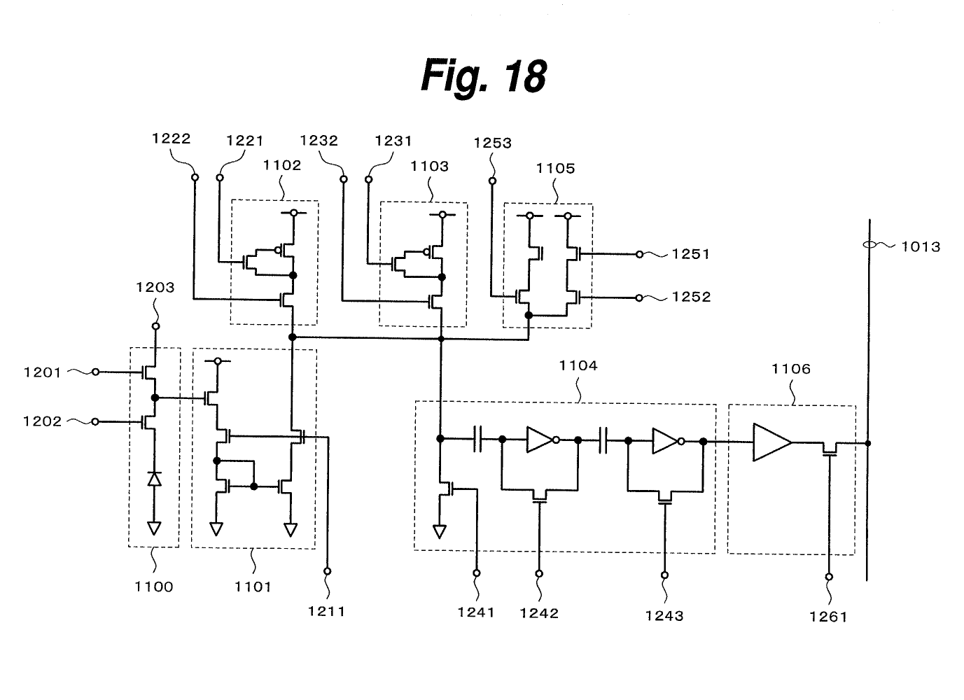

FIG. 18 is a diagram that shows an example of implementing about blocks of the unit pixel of the imaging device shown in FIG. 15.

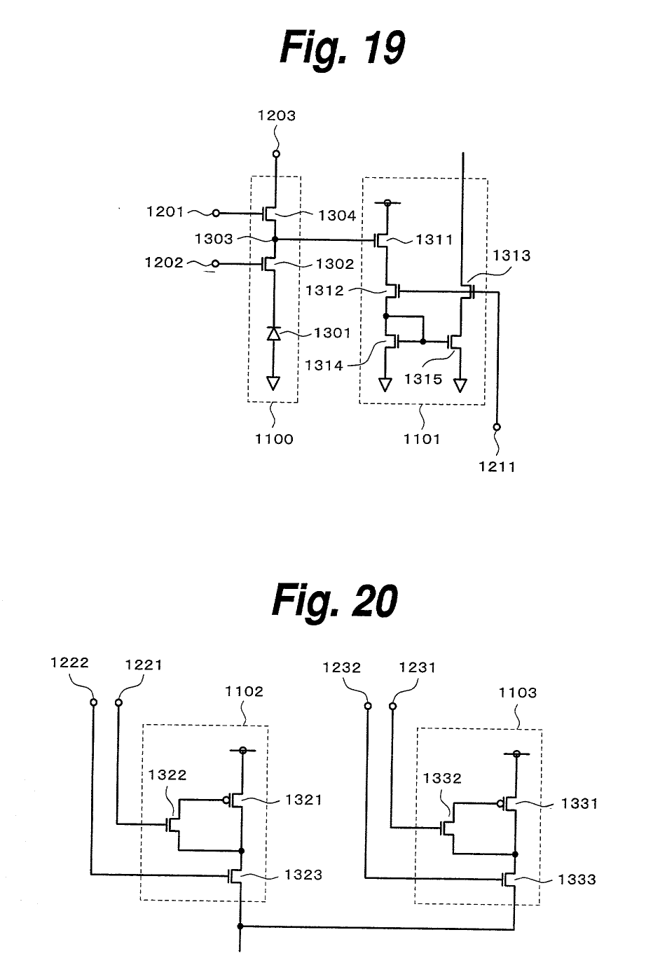

FIG. 19 shows detailed internal configuration of a photoreceptor section 1100 and an amplifier section 1101 in the unit pixel.

The photoreceptor section 1100 includes a photodiode (PD) 1301, transfer transistor (TX) 1302, floating diffusion (FD) 1033, and reset transistor (RST) 1304. The reset transistor 1304 is supplied with a reset pulse (φRST) 1201, and the transfer transistor (TX) 1302 is supplied with a transfer pulse (φTX) 1202. The input pulses 1201, 1202 correspond to the photoreceptor control pulse 1200 (already explained).

Since a reset voltage (VR) 1203 is applied to the reset transistor RST 1304, once the reset transistor RST 1304 is changed to the ON state by inputting the reset pulse φRST 1201, the floating diffusion FD 1303 is reset to a potential determined by the value of the reset voltage VR 1203. When the transfer transistor TX 1302 turns ON in response to the transfer pulse φTX 1202, electrons by photoelectric conversion by the photodiode PD 1301 are transferred o the floating diffusion FD 1303, and a potential corresponding to the number of electrons is generated in the floating diffusion FD 1303.

Potential of the floating diffusion FD 1303 corresponds to the quantity of received light, and it is considered to be approximately proportional to the luminosity as far as the photo diode PD 1301 is not saturated. The brighter, i.e. the more the quantity of received light, the more the electrons generated by photoelectric conversion, and the potential of the floating diffusion DF 1303 decreases. In contrast, the darker, the fewer the electrons generated, and he potential of the floating diffusion FD 1303 increases.

The amplifier section 1101 includes an amplifier transistor (QA) 1311, amplifier read-out first gate (AGF) 1312, amplifier read-out second gate (AGS) 1313, and current mirror circuits 1314 and 1315. The amplifier read-out first gate AGF 1312 and the amplifier read-out second gate (AGS) 1313 are supplied with an amplifier read-out pulse (φAG) 1211 as an amplifier control pulse 1210.

The gate of the amplifier transistor QA 1311 is currently applied with the potential in the floating diffusion 1303 of the photoreceptor section 1100. Under the condition, when the amplifier read-out pulse φAG 1211 is applied, a current determined by the source-gate potential of the amplifier transistor QA 1311 flows through the amplifier read-out first gate AGF 1312 and the mirror transistor 1314, and a current determined by the size of the mirror transistors 1315, 1314 flows through the amplifier second gate AGS 1313 and the mirror transistor 1315.

As the potential of the floating diffusion FD 1303 gets higher, the more the current that flows. That is, the darker the received light, the more the current that flows through the amplifier second gate AGS 1313 and the mirror transistor 1315. In contrast, the brighter the received light, the smaller the current.

FIG. 20 shows detailed internal configuration of the first memory section 1102 and the second memory section 1103 in the unit pixel shown in FIG. 15.

The first memory section 1102 includes a first memory transistor (QMF) 1321, first memory transistor switch (MSWF) 1322, and first memory gate (MGF) 1323. The first transistor switch MSWF 1322 is supplied with a first memory pulse (φMSWF) 1221, and the first memory gate MGF 1323 is supplied with a first memory gate pulse (¢MGF) 1222, both as the first memory control pulse 1220 (explained above).

Similarly, the second memory section 1103 includes a second memory transistor (QMS) 1331, second memory transistor switch (MSWS) 1332, and second memory gate (MGS) 1333. The second memory transistor switch MSWS 1332 is supplied with a second memory pulse (φMSWS) 1231, and the second memory gate MGS 1333 is supplied with a second memory gate pulse (φMGS) 1232, both as the second memory control pulse 1230.

Both the first memory gate MGF 1323 and the second memory gate MGS 1333 are connected to the amplifier section 1101 such that a signal current amplified by the current mirror can be input.

The first memory section 1102 and the second memory section 1103 form a so-called current copier circuit, or a dynamic current mirror circuit, and can store the signal current through their following operations.

First, during the period where the first memory gate MGF 1323 is ON with the first memory pulse φMGF 1222, when the first memory transistor switch MSWF 1322 is changed ON by the first memory pulse φMSWF 1221, the gate and the drain of the first memory transistor QMF 1321 are short-circuited, and the signal current flows into the first memory transistor QMF 1321 under the so-called saturation region mode through the first memory gate MGF 1323. Then, since the signal current continuously flows even when only the first memory transistor switch MSWF 1322 is changed OFF, the gate potential of the first memory transistor QMF 1321 maintains a value necessary for flowing the signal current. After that, when the first memory gate MGF 1323 is changed OFF, the signal current does not flow. However, as long as the gate potential of the first memory transistor QMF 1321 is maintained, the signal current is stored.

That is, when the first memory gate MGF 1323 is again changed ON by the first memory gate pulse φMGF 1222, the signal current heretofore stored by the maintained gate potential of the first memory transistor QMF 1321 again starts flowing. Also the second memory section 1103 can store the signal current in the second memory transistor QMS 1331 through the same operations.

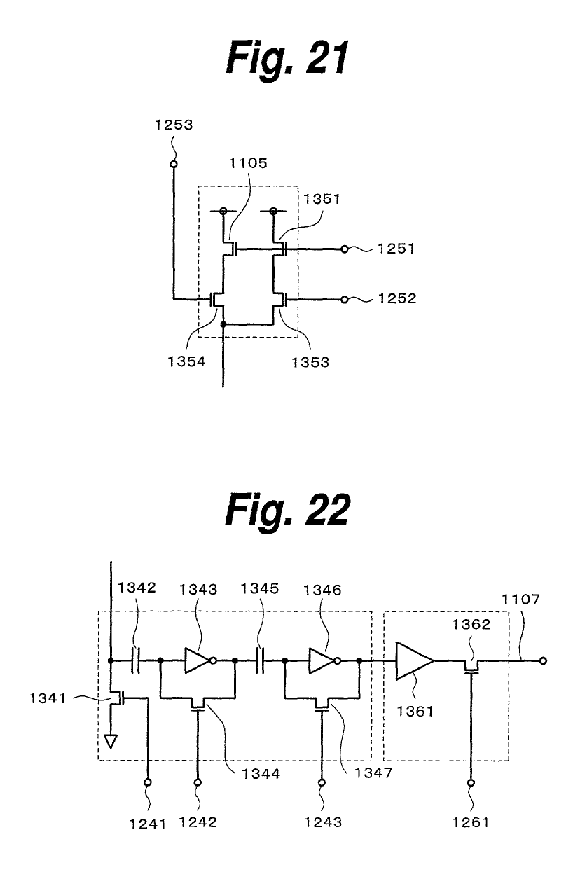

FIG. 21 shows internal configuration of the bias section 1105 in the unit pixel in detail.

The bias section 1105 includes a first bias transistor (QBF) 1351, second bias transistor (QBS) 1352, first bias gate (GBF) 1353, and second bias gate (GBS) 1354. As the bias control pulse 1250, a bias voltage (VB) 1251 is applied to the first bias transistor QBF 1351 and the second bias transistor QBS 1352, a first bias gate pulse (φGBF) 1252 is applied to the first bias gate GBF 1353, and a second bias gate pulse (φGBS) 1253 is applied to the second bias gate GBS 1354, respectively (explained before).

Outputs of the first bias gate GBF 1353 and the second bias gate GBS 1354 are connected to outputs of the first memory section 1102 and the second memory section 1103 such that a bias current can be added to signal currents output from the respective memory sections 1102, 1103.

Since the common bias voltage VB 1251 is applied to the gates of the first bias transistor QBF 1351 and the second bias transistor QBS 1352, currents responsive to the transistor sizes can be flown. Therefore, it is possible to give a difference in magnitude between the bias current flowing out when the first bias gate pulse φGBF 1252 is applied to the first bias gate GBF 1353 and the bias current flowing out when the second bias gate pulse φGBS 1253 is applied to the second bias gate GBS 1354.

FIG. 22 shows internal configuration of the comparator section 1104 and the output section 1106 in the unit pixel in detail.

The comparator section 1104 includes a load transistor (QL) 1341, first capacitor (CF) 1342, first inverter (INVF) 1343, first inverter short-circuit switch (SWINVF) 1344, second capacitor (CS) 1345, second inverter (INVS) 1346, and second inverter short-circuit switch (SWINVS) 1347. Then, as the comparator control pulse 1240 (mentioned above), a load pulse (φQL) 1241 is applied to the load transistor QL 1341, a first inverter short-circuit pulse (φINVF) 1242 is applied to the first inverter short-circuit switch SWINVF 1344, and a second inverter short-circuit pulse (φINVS) 1243 is applied to the second inverter short-circuit switch SWINVS 1347, respectively.

The load transistor QL 1341 is connected to outputs of the first memory section 1102, second memory section 1103 and bias section 1105 to input signal currents output therefrom.

The illustrated comparator section 1104 is a so-called chopper-type comparator so as to provide an output responsive to the magnitude of a signal input in the period of resetting the offset by the working point inside the comparator and a signal input after completion of the reset.

First, when the load transistor QL 1341 is changed ON by application of the load pulse φQL 1241, a potential VZ responsive o the magnitude of the signal current to be compared (designated by “IZ”) is generated at the electrode of the first capacitor CF 1342 opposite from the first inverter INVF 1343.

At that time, when the first inverter short-circuit switch SWINVF 1344 is changed ON by application of the first inverter short-circuit pulse φINVF 1242 to short-circuit the first inverter INVF 1343, the input and the output of the first inverter INVF 1343 are equalized in potential (working point potential VTHF of the first inverter INVF 1343), and an electric charge corresponding to the voltage of VZ-VTHF is stored in the first capacitor CF 1342.

If the second inverter INVS 1346 in the subsequent stage is simultaneously short-circuited by the second inverter short-circuit switch SWINVS 1347, when the working point potential of the second inverter INVS 1346 is controlled to VTHS, an electric charge corresponding to the voltage of VTHF-VTHS will be similarly stored in the second capacitor CS 1345.

Then the short-circuiting of the first inverter INVF 1343 is cancelled, and the short-circuiting of the second inverter INVS 1346 is next cancelled.

Subsequently, by flowing a signal current (“IY”) as the other to be compared and again applying the load pulse φQL 1241, a load potential VY corresponding to IY is generated in the load transistor QL 1341. As a result, potential of the capacitor CF 1342 connected to the load transistor QL 1341 changes from VZ to VY.

Assuming that the input-side capacity of the first inverter INVF 1343 is so small that it can be negligible as compared with the first capacitor CF 1342, if VY is larger than VZ, then the potential of the first capacitor CF 1342 connected to the first inverter INVF 1343 rises from VTHF. In contrast, if VY is smaller than VZ, then the input-side potential of the first inverter INVF 1343 decreases, as easily understood. Therefore, when VY>VZ, output of the first inverter INVF 1343 becomes the LOW level, and if VY<VZ, output of the first inverter INVF 1343 becomes the HIGH level.

In response to these behaviors, potentials at opposite ends of the second capacitor CS 1345 also rise or decrease. Therefore, output of the comparator section 1104, i.e. output of the second inverter INVS 1346, becomes the HIGH level under IY>IZ (VY>VZ) and the LOW level under IY<IZ (VY<VZ) in accordance with magnitudes of the signals to be compared.

The output section 1106 includes an output amplifier (BAMP) 1361 and an output gate (GOUT) 1362. As the output control pulse 1260, an output gate pulse (φGOUT) 1261 is applied.

When the output gate pulse φGOUT 1261 is applied, a pixel output (POUT) 1107 of a signal level 89 appropriately converted from the output of the comparator 1104 is output to the vertical signal line 1013.

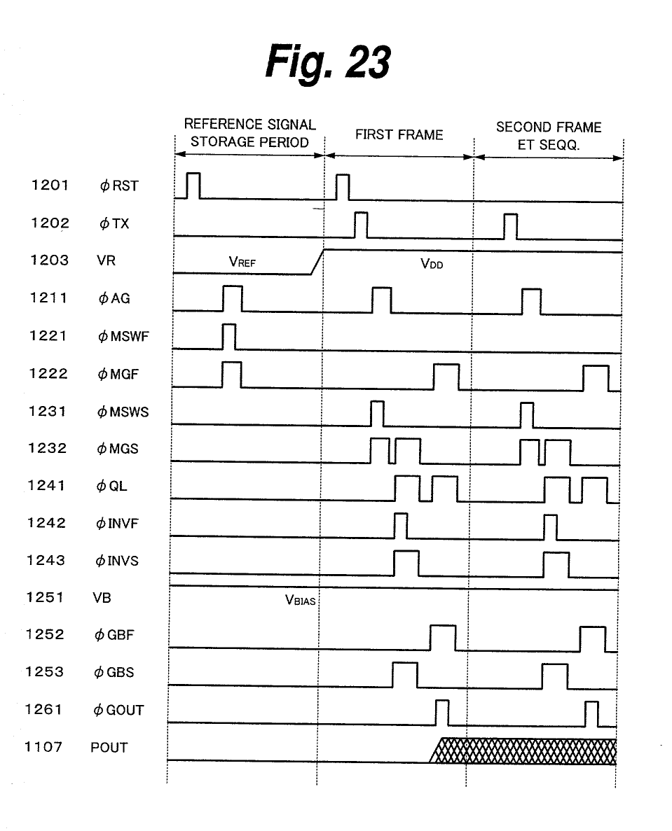

Next explained is the scheme of converting a quantity of received light from an analog signal into a digital signal with reference to the timing chart for conversion of luminosity shown in FIG. 23.

First in a reference signal storage period, executed are procedures for storing a reference signal current in the first memory section 1102.

In the photoreceptor section 1100, under the condition where the reset voltage 1203 is set to VREF, a reset pulse φRST 1201 is applied to set the potential of the floating diffusion FD 1303 to a value corresponding to VREF.

Consecutively, an amplifier read-out pulse φAG is applied in the amplifier section 1101 to render the amplifier read-out first gate AGS 1312 and the amplifier read-out second gate AGS 1313 conductive, thereby to generate in the amplifier transistor QA 1311 a current determined by the potential of the floating diffusion FD 1303, and further to obtain a current (designated by I_{REF}) amplified by the current mirrors 1314, 1315.

At that time, when the first memory pulse φMSWF 1221 and the first memory gate pulse φMGF 1222 are simultaneously applied in the first memory section 1202, that current I_{REF} results in flowing into the first memory transistor QMF 1321 through the first memory gate MGF 1323.

Thereafter, by decreasing the fist memory pulse φMSWF 1221 to the LOW level to cancel the short-circuiting of the first memory transistor QMF 1321, and consecutively canceling the first memory gate pulse φMGF 1222, that current I_{REF} can be stored in the first memory transistor QMF 1321.

Through the above-mentioned operations, procedures in the reference signal storage period are completed.

Next executed are procedures in the first frame.

In the photoreceptor section 1100, under the condition where the reset voltage 1203 is set to the source voltage V_{DD} that is higher than V_{REF}, the reset pulse φRST 1201 is applied to set the potential of the floating diffusion FD 1303 to a value corresponding to V_{DD}.

At that time, since electrons by photoelectric conversion of received light during the former reference signal storage period are stored in the photo diode PD 1301, when the electrons are transferred from the photodiode PD 1301 to the floating diffusion FD 1303 by applying the transfer pulse φTX 1202, the floating diffusion FD 1303 can be set to a potential corresponding to the number of electrons.

Consecutively, an amplifier read-out pulse φAG 1211 is applied in the amplifier section 1101 to render the amplifier read-out first gate AGF 1312 and the amplifier read-out second gate AGS 1313 conductive, thereby to generate in the amplifier transistor QA 1311 a current determined by the potential of the floating diffusion FD 1303, and further to obtain a current (designated by I_{F1}) amplified by the current mirrors 1314, 1315.

At that time, when the second memory pulse φMSWS 1231 and the second gate pulse φMGS 1232 are simultaneously applied in the second memory section 1103, that current I_{F1} results in flowing into the second memory transistor QMS 1331 through the second memory gate MGS 1333.

Thereafter, by decreasing the second memory pulse φMSWS 1231 to the LOW level to cancel the short-circuiting of the second memory transistor QMS 1331, and consecutively canceling the second memory gate pulse φMGS 1232, that current I_{F1} can be stored in the second memory transistor QMS 1331.

After that, there follow procedures for comparison between the reference signal I_{REF} stored in the first memory section 1102 and the signal current I_{F1} of the first frame stored in the second memory section 1103.

First, by applying the second memory gate pulse φMGS 1232 and the load pulse φQL 1241, I_{F1} heretofore stored in the second memory transistor QMS 1331 in the second memory section 1103 is flown into the load transistor QL 1341 in the comparator section 1104.

Further, the second bias gate GBS 1354 is rendered conductive by simultaneously applying the second bias gate pulse φGBS 1253, and the bias current (“I_{BS}” below) generated in he second bias transistor QBS 1352 by application of V_{BIAS} 1251 is flown to the load transistor QL 1341. Therefore, the voltage Y_{F1} determined by the signal currents IF1 and IBS is generated in the load transistor QL 1341.

At that time, by applying the first inverter short-circuit pulse φINVF and the second inverter short-circuit pulse φINVS, inputs and outputs of the first inverter INVF 1343 and the second inverter INVS 1346 are simultaneously short-circuited to reset the working point offset of the comparator section 1104 beforehand.

At this point of time, the voltage Y_{F1}-V_{THF} results in being applied to opposite ends of the first capacitor CF 1342.

By next applying the first memory gate pulse φMGF 1222 and the load pulse φQL 1241 simultaneously, the reference signal current I_{REF} heretofore stored in the first memory transistor QMF 1321 inside the first memory section 1102 is flown to the load transistor QL 1341 inside the comparator section 1104.

At that time, by simultaneously applying he first bias gate pulse φGBF 1252, the first bias gate GBF 1353 is made conductive, and the bias current (“I_{BF}” below) generated in the first bias transistor QBF 1351 by application of V_{BIAS} 1251 is flown in the load transistor QL 1341.

Because the reference signal current I_{REF} and the bias current I_{BF} flow simultaneously, the voltage Y_{REF} results in generating in the load transistor QL 1341.

According to the principle of the comparator's operations already explained, a level responsive to the magnitude relationship between Y_{F1} and Y_{REF} becomes the output of the comparator section 1104, and it is output as the pixel output POUT 1107 to the vertical signal line 1013 when the output gate pulse 4GOUT 1261 is applied via the output amplifier 1361 in the output section 1106.

That is, if I_{F1}>I_{REF} (Y_{F1}>Y_{REF}), then the pixel output POUT 1107 is the LOW level. If I_{F1}<I_{REF} (Y_{F1}<Y_{REF}), then the pixel output POUT 1107 is the HIGH level.

In the second frame et seq., resetting of the floating diffusion FD 1303 by the reset pulse φRST 1201 is not executed. Therefore, a potential determined by the number of electrons stored in the foregoing frames plus electrons generated by photoelectric conversion in a particular frame results in generating in the floating diffusion FD 1303.

For example, in the second frame, in addition to the electrons stored in the floating diffusion FD 1303 in the first frame, electrons generated by photoelectric conversion during the first frame period are also transferred by way of application of the transfer pulse φTX 1202, and according to the total number of electrons, the potential of the floating diffusion FD 1303 is determined.

Thus the second memory transistor QMS 1331 in the second memory section 1103 results in storing the currents I_{F2} (second frame), I_{F3} (third frame), I_{F4} (fourth frame), . . . obtained from the current mirror circuit in the amplifier section 1101 by the potential determined in that manner.

The procedures for comparison with the reference current I_{REF} are the same as those of the first frame.

The operations explained above are for the case of converting the quantity of received light to a digital value expressed with the number of frames when the reference level is fixed.

In the foregoing explanation, the reference level is set up based on the value of the reset voltage VR 1203 in the reference signal storage period, and the bias current to be added to the signal current is determined depending on which of the first bias transistor QBF 1351 and the second bias transistor QBS 1352 inside the bias section 1105 supplies it; however, even if no bias current is added, digital conversion is still possible.

That is, while fixing the first bias gate pulse φGBF 1252 and the second bias gate pulse φGBS 1253 at the LOW level and under I_{BF}=I_{BS}=0, the current difference corresponding to the difference between V_{REF} and V_{DD} results in determining the reference signal level.

To the contrary, while fixing the reset voltage VR 1203 at V_{DD} (that is, constant in all frames), digital conversion is possible by controlling only the bias current. In this case, it is sufficient to set them such that the difference between I_{BF} and I_{BS} equals the current difference corresponding to the difference between V_{REF} and V_{DD}.

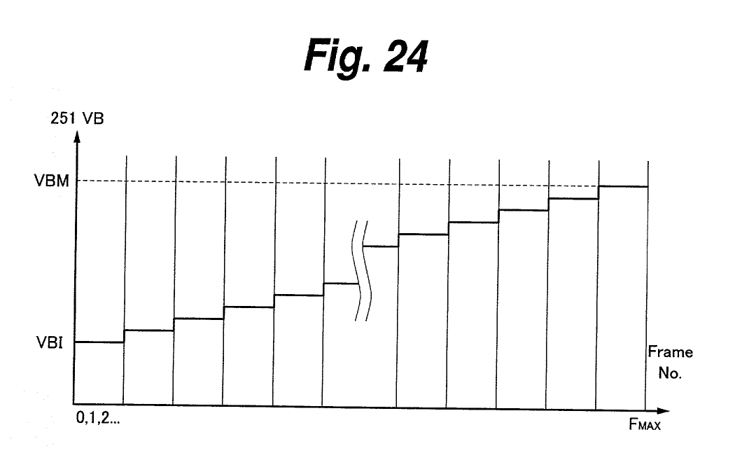

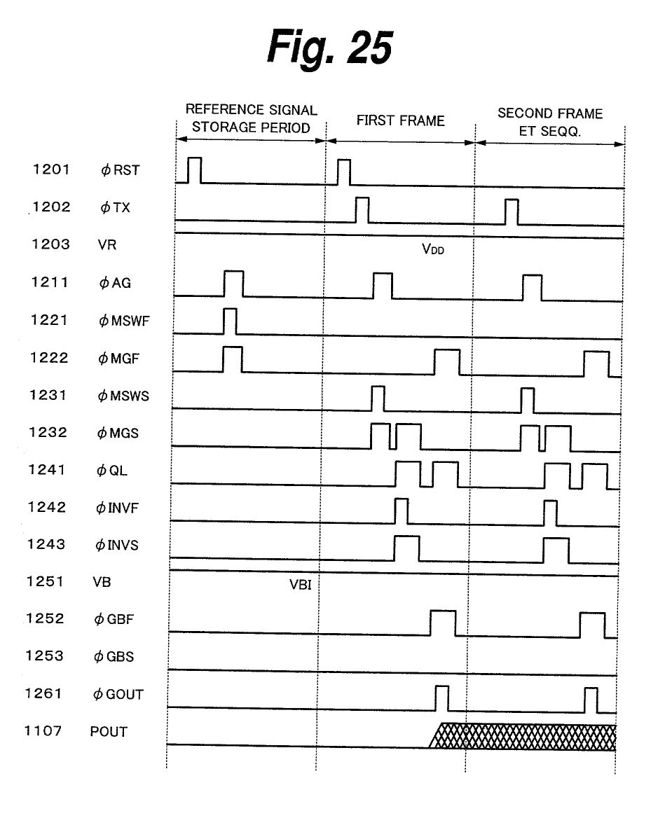

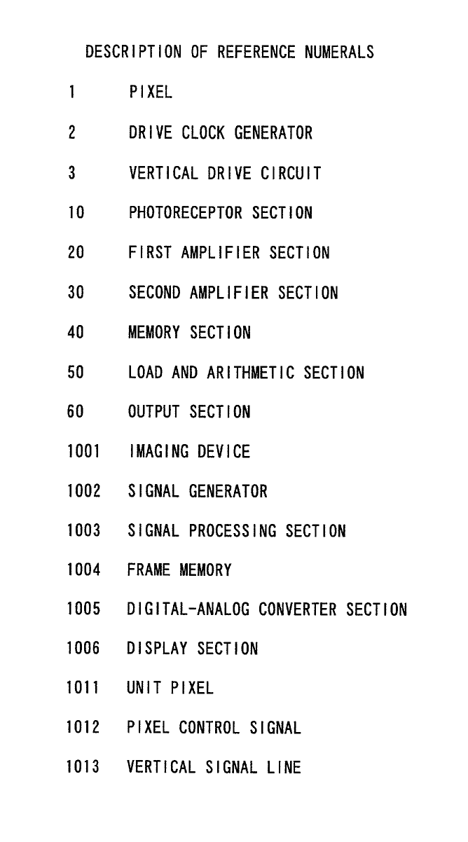

As already explained with reference to FIG. 16, any of the above-explained operations cannot always ensure that any light from very bright light to very dark light is expressed. In this embodiment, therefore, a method of enlarging the dynamic range will be explained below with reference to FIGS. 24 and 25.

This embodiment aims enlargement of the dynamic range by modifying the circuit arrangement with the unit pixels as shown in FIG. 18 such that the bias current varies with time to provide an effect equivalent to changes of the reference signal with time as shown in FIG. 17.

For this purpose, as shown in FIG. 24, the bias voltage VB 1251 is adjusted to VB=VBI in the first frame and thereafter gradually increased every-frame or every several frames such that it becomes V_{B}=V_{BM} in the final frame F_{MAX}. On the other hand, the reset voltage VR 1203 is maintained constant at V_{DD} to the final frame.

FIG. 25 is a timing chart approximately the same as that shown in FIG. 23 but different in that the reset voltage V_{R} 1203 is V_{DD} even in the reference signal storage period. Thus the reference signal is stored in this status in the first memory section 1102.

In the first frame et seq., what is different from FIG. 23 lies in that, when the signal of the first memory section 1102 is read out and compared with the signal responsive to the intensity of received light stored in the second memory section 1103, the first bias gate pulse φGBF 1252 becomes the HIGH level to add the bias signal from the first bias transistor QBF 1351 as well, but the second bias gate pulse φGBS 1253 is maintained in the LOW level not to add the bias current generated in the second bias transistor QBS 1352. By this kind of drive control makes it possible to change the bias voltage VB 1251 to render the bias current generated in the first bias transistor QBF 1351 variable and to change the reference signal level every frame or every several frames.

Therefore, according to the principle shown in FIG. 17 and Equations 17 and 22, imaging enlarged in dynamic range can be realized.

Finally, with reference to FIGS. 13 and 14, a method of processing respective pixel outputs will be explained.

The signal level of the pixel output POUT 1107 is transferred to the horizontal output circuit 1030 via the vertical signal line 1013 in each frame. In the horizontal output circuit 1030, two alternative ways of outputting pixel outputs, namely, the first for converting pixel outputs POUT 1107 transferred in parallel from respective pixel columns into a serial form and outputting it outside the imaging device, and the second for directly outputting the pixel outputs in parallel columns as transferred from respective pixel rows.

A pixel signal output from the imaging device 1001 is input to the signal processing section 1003 and checked there whether the signal level is HIGH or LOW for each pixel. If it is the HIGH level, the frame number at that time is written in an address prepared for each pixel inside the frame memory 1004. However, writing is effected only when the signal first becomes the HIGH level, and not when the signal becomes so second time, et seqq. The frame number written at that time is just the value for expressing the luminosity.

To display this luminosity on the display section 1006, the following procedures are taken.

First, the frame number stored in the frame memory 1004 is read out for each pixel, and this value is converted in the signal processing section 1003, using Equations 17 through 22. The skilled in the art will readily understand that this processing can be easily realized by using an operation of digital signals. Thus the converted digital signals are sequentially transferred to the digital analog converter sections 1005 for respective pixels and converted into analog signals suitable for the display section 1006.

This means that they are converted to standard video signals, such as NTSC (National Television System Committee) signals or VGA (Video Graphic Array) signals.

Thus an output from the digital analog converter section 1005 is displayed by the display section 1006.

[Addenda]

The invention has been explained in detail by way of specific embodiments. Apparently, however, the skilled in the art will be able to modify or change those embodiments within the scope of the invention. That is, the invention has been explained by way of examples, and should not be construed to be limitative to those examples. For evaluating the scope of the invention, claims should be taken into consideration.

As described above, according to the invention, it is possible to provide an excellent imaging system having a compact and lightweight structure and its drive control method.

The invention can also provide an excellent imaging system realized by using a technique used for manufacturing a semiconductor such as CMOS (Complementary Metal-Oxide Semiconductor), and its drive control method.

The invention can further provide an excellent imaging system made by integrating various kinds of circuit modules for processing detection signals in respective pixels, and its drive control method.

The invention can also provide an imaging system capable of realizing AD (Analog-to-Digital) conversion and at least one further operation of a photo diode output by using circuit modules on a common chip, and its drive control method.

The invention can convert luminosity of an object, which is an analog value, to a digital value by using imaging devices having a circuit arrangement for operating changes of luminosity of the object with time. Therefore, the imaging system need not include a circuit exclusive for analog-digital conversion, and can prevent an increase of the circuit scale as compared with other concepts having equivalent functions.

The invention can also realize imaging of a wide dynamic range by adjusting the time intervals for integration of the reference signal level and luminosity of the object upon the A/D conversion process for converting an analog value to a digital value.

The invention can also realize imaging resistant to random noise by integration of luminosity of the object with time upon conversion of detection signals of respective pixels from analog values to digital values.

The invention can also provide an excellent imaging system that ensures an image reproducing all regions from dark regions to bright regions by enlarging the dynamic range simultaneously upon converting the intensity of received optical signal from an analog value to a digital value, and its drive control method. Additionally, it can freely change the method of expressing the intensity of received optical signals by changing the timing of drive pulses supplied to respective pixels and the existence or absence of pulses.

1. An imaging system including a photoreceptor section for generating an electric signal responsive to luminosity of an object, an amplifier section for amplifying an output signal of said photoreceptor section, a plurality of memory sections for storing the electric signal amplified by said amplifier section in form of a current signal, a load section for converting current outputs from said memory sections into voltages, an arithmetic section for operating an output signal from said load section, an output section for externally outputting a result of the operation by said arithmetic section, and a drive control section for controlling driving of said sections, characterized in:
said drive control section having a drive control mode for controlling one of said memory sections to store a current signal corresponding to a reference signal level, controlling the other of said memory sections to store a current signal corresponding to luminosity of an object while progressing integration thereof with time, and controlling said arithmetic section to compare luminosity of the object with the reference signal level on the basis of current signals read out from said memory sections; and
said arithmetic section outputting an identifying signal at the moment when the signal indicative of luminosity of the object exceeds the reference signal level.

2. The imaging system according to claim 1 wherein said drive control section has a different drive control mode for controlling said memory sections to store current signals corresponding to luminosity of the object at different points of time, respectively, and controlling said arithmetic section to compare luminosity of the object at respective points of time, based on current signals read out from respective said memory sections, and said arithmetic section outputs an identifying signal at the moment when the signal indicative of luminosity of the object exceeds the reference signal level.

3. The imaging system according to claim 1 wherein said amplifier section includes mirror transistors so connected that gate electrodes thereof are opposed to each other, and amplifies a current signal according to the current mirror principle.

4. The imaging system according to claim 1 wherein said memory sections store current signals according to the current copy principle.

5. The imaging system according to claim 1 wherein said sections are provided for each pixel, and said imaging system further comprises an optical area having a matrix arrangement of a number of pixels aligned in rows and columns, a drive circuit for generating signals for driving respective said pixels aligned in said optical area, and an output circuit for externally outputting output signals from respective said pixels, which all are packaged on a common circuit chip.

6. A drive control method of an imaging system including a photoreceptor section for generating an electric signal responsive to luminosity of an object, an amplifier section for amplifying an output signal of said photoreceptor section, a plurality of memory sections for storing the electric signal amplified by said amplifier section in form of a current signal, a load section for converting current outputs from said memory sections into voltages, an arithmetic section for operating an output signal from said load section, and an output section for externally outputting a result of the operation by said arithmetic section, which method realizes a drive control mode comprising:
(a) a step of storing a current signal corresponding to a reference signal level in one of said memory sections;
(b) a step of storing a current signal corresponding to luminosity of an object in the other of said memory sections while progressing integration thereof with time;
(c) a step of comparing a reference signal level and luminosity of the object in said arithmetic section, based on said current signals read out from said memory sections; and
(d) a step of outputting an identifying signal from said arithmetic section at the moment when the signal indicative of luminosity of the object exceeds the reference signal level,
then measuring a period of time required for the luminosity of the object measured by said identifying signal output in said step (d) to exceed said reference signal level, and converts the luminosity of the object an analog value to a digital value on the basis of a result of the measurement.

7. The drive control method of an imaging system according to claim 6 further realizing a different drive control mode comprising:
(p) a step of storing current signals corresponding to luminosity of the object at different points of time in respective said memory sections;
(q) a step of comparing luminosity of the object at different points of time in said arithmetic section on the basis of current signals read out from said memory sections; and
(r) a step of outputting an identifying signal from said arithmetic section at the moment when luminosity of the object changes,
and thereby operating changes of luminosity of the object with time at a high speed.

8. The drive control method of an imaging system according to claim 6 wherein said amplifier section includes mirror transistors so connected that gate electrodes thereof are opposed to each other, and amplifies a current signal according to the current mirror principle.

9. The drive control method of an imaging system according to claim 6 wherein said memory sections store current signals according to the current copy principle.

10. The drive control method of an imaging system according to claim 6 wherein said sections are packaged on a common circuit chip.

11. An imaging system including a photoreceptor section for generating an electric signal responsive to luminosity of an object, an amplifier section for amplifying an output signal of said photoreceptor section, a plurality of memory sections for storing the electric signal amplified by said amplifier section in form of a current signal, a comparator section for introducing and comparing signals read out from said memory sections into voltages, and an output section for externally outputting a result of the comparison by said comparator section as a pixel signal, characterized in:
one of said memory sections storing a current signal corresponding to a reference signal level whereas the other of said memory sections stores a current signal corresponding to luminosity of an object; and
said comparator section comparing said reference signal level input from said one of the memory sections with a signal input from the other memory section while gradually raising said reference signal level with time.

12. An imaging system including a photoreceptor section for generating an electric signal responsive to luminosity of an object, an amplifier section for amplifying an output signal of said photoreceptor section, a plurality of memory sections for storing the electric signal amplified by said amplifier section in form of a current signal, a comparator section for introducing and comparing signals read out from said memory sections into voltages, a bias section for adding a bias signal to respective signals input to said comparator section, and an output section for externally outputting a result of the comparison by said comparator section as a pixel signal, characterized in:
one of said memory sections storing a current signal corresponding to a reference signal level whereas the other of said memory sections stores a current signal corresponding to luminosity of an object; and
said bias section adding a bias signal to the signal input to said one of the memory sections such that said reference signal level gradually rises with time.

13. The imaging system according to claim 12 wherein said amplifier section includes mirror transistors so connected that gate electrodes thereof are opposed to each other, and amplifies a current signal according to the current mirror principle.

14. The imaging system according to claim 12 wherein said memory sections store current signals according to the current copy principle.

15. The imaging system according to claim 12 wherein said sections are provided for each pixel, and said imaging system further comprises an optical area having a matrix arrangement of a number of pixels aligned in rows and columns, a drive circuit for generating signals for driving respective said pixels aligned in said optical area, and an output circuit for externally outputting output signals from respective said pixels, which all are packaged on a common circuit chip.

16. A drive control method of an imaging system of a type including a photoreceptor section for generating an electric signal responsive to luminosity of an object, an amplifier section for amplifying an output signal of said photoreceptor section, and a plurality of memory sections for storing the electric signal amplified by said amplifier section in form of a current signal, thereby to output a result of comparison of signals read out from said memory sections as a pixel signal, comprising:
(a) a step of storing a current signal corresponding to a reference signal level in one of said memory sections;
(b) a step of storing a current signal corresponding to luminosity of an object in the other of said memory sections;
(c) a step of raising the reference signal level read out from said one of the memory sections gradually with time;
(d) a step of comparing the current signal read out from said other memory section with said reference signal level gradually raised with time by said step (c); and
(e) a step of outputting a result of comparison by said step (d) as a pixel output.

17. The imaging system according to claim 16 wherein said amplifier section includes mirror transistors so connected that gate electrodes thereof are opposed to each other, and amplifies a current signal according to the current mirror principle.

18. The imaging system according to claim 16 wherein said memory sections store current signals according to the current copy principle.
